(19) United States
(12) Patent Application Publication
(10) Pub. No.: US 2008/0201341 A1
(43) Pub. Date: Aug. 21, 2008

(54) CONTENTS MANAGEMENT METHOD

(76) Inventors: Takuya Okamoto, Machida (JP); Nobuo Beniyama, Yokohama (JP); Tatsundo Aoshima, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/968,241

(22) Filed: Jan. 2, 2008

(30) Foreign Application Priority Data
Feb. 19, 2007 (JP) 2007-037896

(51) Int. Cl. G06F 17/30

(52) U.S. Cl. 707/100; 707/E17.032

(57) ABSTRACT

An increase in the amount of resources necessary for storing contents is prevented, and a wait time taken from issuance of a content read request from a client to start of replay of the content is shortened. A file server stores header parts of contents cut off from heads of the contents in a content cache which can read the contents at a speed higher than a storage. When accepting the content read request from a client, the file server first returns the header part of the content stored in the content cache to the client. During replay of the content in the client, the file server reads out remaining parts of the content in the storage subsequent to the returned header part of the content, and returns them to the client.

### INCORPORATION BY REFERENCE

The present application claims priority from Japanese application JP2007-037896 filed on Feb. 19, 2007, the content of which is hereby incorporated by reference into this application.

### BACKGROUND OF THE INVENTION

The present invention relates to a method of managing a content cache on a file server such as a NAS (Network Attached Storage) and also to a method of controlling the reading operation of data from the file server.

In these years, as broadband networks expand, a media service for providing a large capacity of stream content such as a high quality of video stream has been increasingly expanded. Such a content is stored in a file server such as the NAS to be supplied to users via a media server such as a Web server. In the past, the communication performance of a network has formed one of the performance bottlenecks of the media service. As the band of a network is broadened, however, the performance of the file server for reading out data from a disk in the content storing storage has formed a bottleneck. Meanwhile, such a content sharing service as to allow users to freely register a content is also increasingly expanded. It is difficult in such service to previously predict what kind of content is registered and a frequency of access to the content.

In each of the media servers, the band of a network connected between the media server and a content distributing destination and the load of the media server become important factors which determine the content distribution performance. For this reason, when a plurality of contents are present, one of the media servers to be accessed is controllably selected on the basis of the network band and the access conditions to the media servers. One of the prior art methods of identifying a media server as an access destination from a client is disclosed in JP-A-2003-256303.

Another technique for securing an access performance by holding a content having a high access frequency in a plurality of cache servers in each media server, whereby only the content having high access frequencies can be stored in the cache servers. One of such prior art techniques is disclosed in JP-A-2003-242020.

A prior art shown in JP-A-8-18945 discloses a method of combining a plurality of content read requests accepted in a predetermined period of time into a single read request. This method can reduce a reading load to a storage.

A prior art shown in JP-A-2004-120376 discloses a method of distributing only the header part of a content such as a stream by mail and requesting the distribution of the subsequent data during the replay of the header part. This method can reduce a time taken before the replay of the content.

### SUMMARY OF THE INVENTION

The prior art of the aforementioned JP-A-2003-242020 has a problem that the content storing operation requires more resources, although a wait time taken from the issuance of the content read request from the client to the start of the replay of the stream content at the client can be shortened by storing the high-access-frequency content in the cache servers

In the prior art of the aforementioned JP-A-2004-120376, a time required until content replay in a client can be reduced. However, the distributor distributes the header part of the content to the client by mail, and determines whether or not the client replays the header part of the distributed content. For this reason, the replay of the distributed content is determined by the distributor and thus content distribution cannot be carried out according to a user's request in this prior art.

In view of the above problems in the prior arts, it is therefore an object of the present invention to prevent the amount of resources necessary for content storing operation from being increased and to shorten a wait time from the issuance of a content read request from a client to the start of replay of the content at the client.

In accordance with an aspect of the present invention, the above problems are solved by providing one or a plurality of storage servers having one or more storages and also a file server communicatable with one or a plurality of clients which issue a content read request. The file server includes a content cache which can store part of the content stored in a storage therein. The file server stores the header part of the content cut out from the header of the content in the content cache which can read out the content at a speed higher than the storage. When the file server accepts a content read request from a client, the file server returns the header part of the content stored in the content cache to the client, and also returns the remaining part of the content subsequent, which is stored in the storage, to the returned header part of the content.

In accordance with the present invention, an increase in the amount of resources necessary for content storing operation can be prevented, and the wait time taken from the issuance of the content read request from the client to the start of replay of the content at the client can be reduced.

### BRIEF DESCRIPTION OF THE DRAWINGS

FIG. 1 is a configuration of a system;

FIG. 2 shows a relation between program modules;

FIG. 3 is a sequence diagram showing content reading and distributing processes in the system;

FIG. 4 is a diagram for explaining a stream data structure and content blocks;

FIG. 5 is a flow chart of a content replay program in a client;

FIG. 6 is a flow chart of a content distribution program in a media server;

FIG. 7 shows a data structure of a content distribution destination management table used by the content distribution program of the media server;

FIG. 8 is a flow chart of content read request operations in a content management program of a media server;

FIG. 9 shows a data structure of a content management table in the media server;

FIG. 10 is a flow chart of operations of a content read program in the media server;

FIG. 11 is a flow chart of operations of a read request management program in a file server;

FIG. 12 is a flow chart of a content absence/presence checking process of a file system management program in the file server;

FIG. 13 is a flow chart of an access frequency updating process of an access frequency management program of the file server;

FIG. 14 shows a data structure of a content access frequency management table used by the access frequency management program of the file server;

FIG. 15 is a diagram for explaining how to determine an access frequency counter used in the content access frequency management table in the access frequency management program of the file server and also how to calculate the latest access frequency;

FIG. 16 shows a data structure of a content storing destination management table in the file server;

FIG. 17 shows a half of a flow chart of a read control program in the file server;

FIG. 18 is the remaining half of the flow chart of the read control program in the file server;

FIG. 19 shows a data structure of a content read management table used by the read control program of the file server;

FIG. 20 is a flow chart of a storage performance monitoring process of a storage performance management program of the file server;

FIG. 21 shows a storage access performance management table used by the storage performance management program of the file server;

FIG. 22 shows a relationship among the calculation of a limit value of a storage read performance based on a content replay rate, a change in a storage read performance with time, and a limit value of a storage access frequency;

FIG. 23 is a flow chart of a storage performance referring process of the storage performance management program of the file server;

FIG. 24 is a flow chart of operations of a cache control program in the file server;

FIG. 25 shows diagrams for explaining changes in a total read request number caused by modifications in the header part of a content stored in the content cache;

FIG. 26 is a diagram for explaining an improvement in the storage read performance caused by an increase in the size of the header part of the content stored in the content cache;

FIG. 27 shows a half of a flow chart of a cache area releasing process having a low use frequency in the cache control program of the file server;

FIG. 28 shows the remaining half of the flow chart of the cache area releasing process having the low use frequency in the cache control program of the file server;

FIG. 29 is a flow chart of operations of a content registration program in a client;

FIG. 30 is a flow chart of operations of a content acceptance program in the media server;

FIG. 31 is a flow chart of operations of the content management program in the media server;

FIG. 32 is a flow chart of operations of a content update program in the media server;

FIG. 33 is a flow chart of operations of an update request management program in the file server;

FIG. 34 is a flow chart of a content deleting process in an update control program of the file server;

FIG. 35 is a flow chart of a content writing process in the update control program of the file server; and

FIG. 36 is a flow chart of a cache storing process for the header part of the content in the cache control program of the file server.

### DESCRIPTION OF THE EMBODIMENT

The best mode (which will be referred to as the embodiment, hereinafter) for embodying the present invention will be explained in detail with reference to the accompanying drawings.

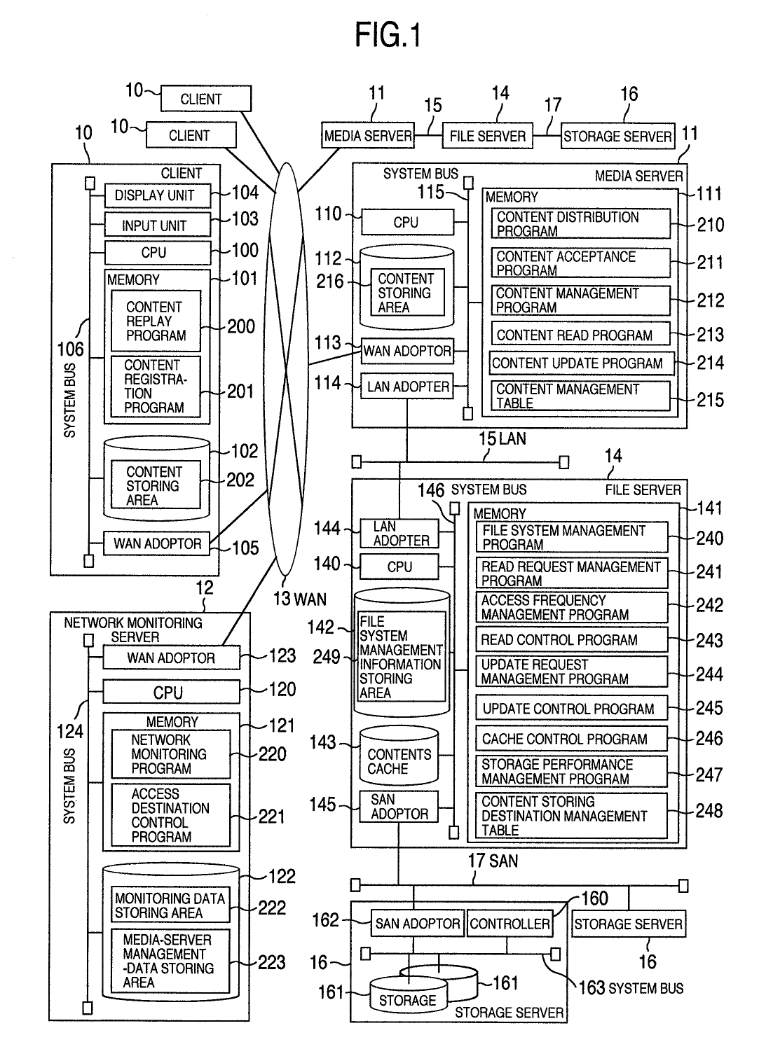

FIG. 1 shows a configuration of a system in accordance with an embodiment of the present invention.

In this system configuration, a client 10, a media server 11, and a network monitoring server 12 are interconnected by a WAN (Wide Area Network) 13. One or a plurality of such clients 10 and one or a plurality of such media servers 11 are present on the WAN 13. The network monitoring server 12 acts to determine the media server 11 to which each client 10 is to be connected on the basis of various types of information including the distance of a connection route from each client 10 to each media server 11, the load of the WAN 13, and access conditions to the media server 11.

Each media server 11 is connected to a file server 14 via a LAN (Local Area Network) 15, and the file server 14 is connected to one or a plurality of storage servers 16 via a SAN (Storage Area Network) 17. A content to be distributed by each media server 11 is stored in a storage 161 of the storage server 16 via the file server 14.

The media server 11 is a computer which includes a CPU (Central Processing Unit) 110, a memory 111, a hard disk 112, a WAN adoptor 113, and a LAN adoptor 114, which are interconnected by a system bus 115. Stored in the memory 111 are a content distribution program 210, a content acceptance program 211, a content management program 212, a content read program 213, a content update program 214, and a content management table 215. The hard disk 112 has a content storing area 216 having registered contents.

The file server 14 is a computer which includes a CPU 140 as a processor, a memory 141 as a data storing device, a hard disk 142, a content cache 143, a LAN adoptor 144 as a first communication device, and a SAN adoptor 145 as a second communication device, which constituent elements are interconnected by a system bus 146. Stored in the memory 141 are a file system management program 240, a read request management program 241, an access frequency management program 242, a read control program 243, an update request management program 244, an update control program 245, a cache control program 246, a storage performance management program 247, and a content storing destination management table 248. The hard disk 142 has a management information storing area 249 to be used by the file system management program 240.

The storage server 16 includes one or a plurality of the storages 161, a controller 160, and a SAN adoptor 162, which are interconnected by a system bus 163. The writing of content to the storage 161 of the storage server 16 and the reading of the content therefrom are controlled by the controller 160.

The client 10 is a computer which includes a CPU 100, a memory 101, a hard disk 102, an input unit 103 such as a keyboard or a mouse, a display unit 104 such as a liquid crystal display, and a WAN adoptor 105, which are interconnected by a system bus 106. Stored in the memory 101 are a content replay program 200 and a content registration program 201. The hard disk 102 has a content storing area 202 having a content to be displayed on the display unit 104 or to be registered in the media server 11. In this connection, although it is assumed in the present embodiment that the client 10 communicates with the file server 14 via the media server 11, the client 10 may communicate with the file server 14 not via the media server 11. In this case, the content replay program 200 and the content registration program 201 are connected to the read request management program 241 and the update request management program 244 respectively.

The network monitoring server 12 is a computer which includes a CPU 120, a memory 121, a hard disk 122, and a WAN adoptor 123, which are interconnected by a system bus 124. Stored in the memory 121 are a network monitoring program 220 and an access destination control program 221. The hard disk 122 has a monitoring data storing area 222 for storing information about a network performance collected via the WAN 13 therein and a media-server management-data storing area 223 for storing a connection destination information on the media server 11 therein.

In the aforementioned system configuration, a program or a table to be stored in the memories of each client and server is usually stored in the hard disk, and when the program is activated, the program is read into the memory. In the illustrated example, however, explanation of such programs and table stored in the hard disk is omitted.

In the present embodiment, the network monitoring server 12 is implemented by utilizing the prior art disclosed in JP-A-8-18945. Since it is assumed in the following explanation that the media server 11 for the client 10 to be connected is already determined by the network monitoring server 12, explanation of the network monitoring server 12 is omitted.

It is also assumed in the following explanation that, when various types of programs are described as processing entities, the processing is implemented by hardware by the CPU which is mounted in the client or the server which executes the various types of programs stored in the memory. Such processing may also be carried out by exclusive hardware.

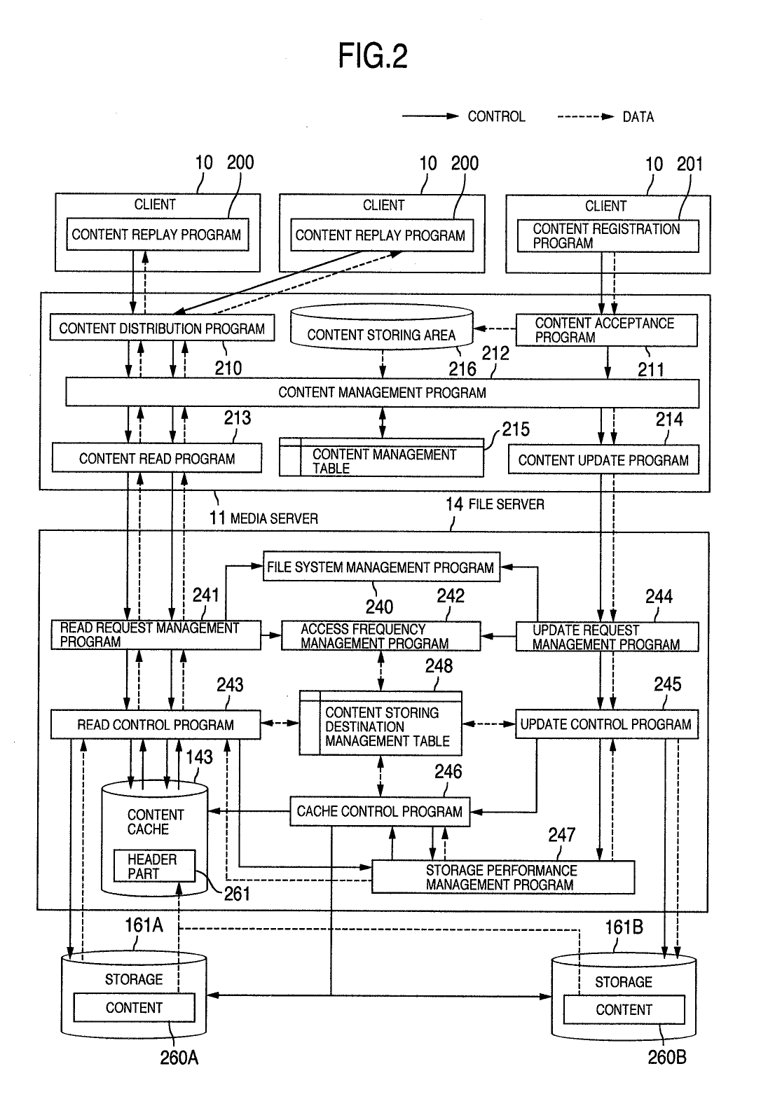

FIG. 2 shows a relationship among various types of program modules which operate in the media server 11 and the file server 14 when the content replay program 200 and the content registration program 201 are executed in the client 10 connected to the media server 11.

The media server 11 controls content processing operations including content distributing, registering, and deleting operations under control of the content management program 212. The function of the file server 14 is implemented by the file system management program 240. It is assumed in the present embodiment that the file system management program 240 is executed based on file system management functions supplied from a general OS (Operating System) which operates in the file server 14, and detailed explanation thereof is omitted. In the present embodiment, explanation will be made as the file system management functions as to functions of checking the presence or absence of a file managed in the file server 14 and updating file system management information upon file registration and deletion.

Explanation will first be made as to the processing procedure of each program when the content replay program 200 of the client 10 issues a content distribution request to the content distribution program 210 of the media server 11.

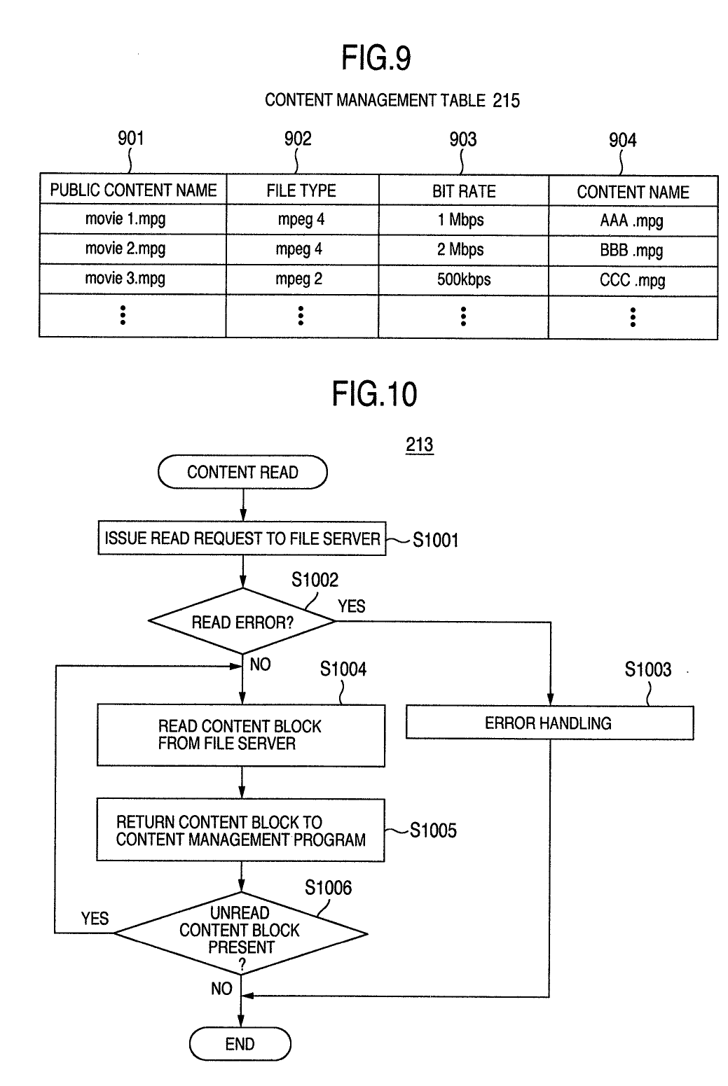

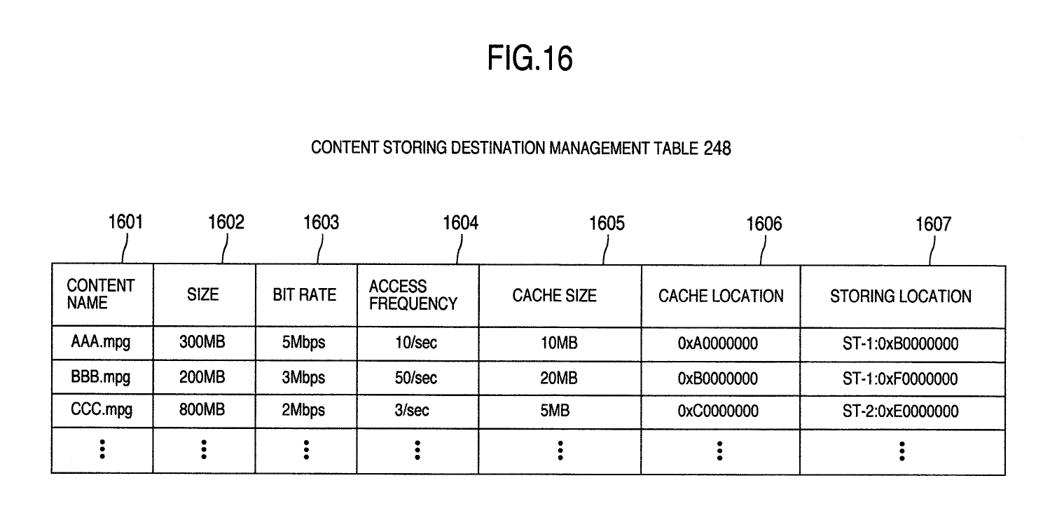

The content distribution program 210 issues a content read request instructed by the client 10 to the content management program 212. The content management program 212 searches the content management table 215, acquires a content name as a content identifier in the file server 14, and issues a content read request from the file server 14 to the content read program 213. A data structure of the content management table 215 is shown in FIG. 9. The content read program 213 is connected to the read request management program 241 of the file server 14, and requires the program to read the content with the specified content name. The read request management program 241 checks whether or not the content with the specified content name is present under control of the file system management program 240. In the absence of the content, the file system management program 240 returns an error to the read request management program 241. In the presence of the content, the file system management program 240 calls the access frequency management program 242, and updates an access frequency (refer to FIG. 16) which is stored in the content storing destination management table 248 and which corresponds to the content. A data structure of the content storing destination management table 248 is shown in FIG. 16.

Next, when the read request management program 241 calls the read control program 243, the read control program 243 read out a header part (content header part) 261 of the content managed by the content cache 143 of the file server 14, reads out a content 260A stored in a storage 161A, and returns the read-out content (the header part 261 and the content 260A) to the media server 11 via the read request management program 241. Now, when a plurality of read requests for the same content 260A are present and these read requests take place at such timing that reading operations of the content 260A from the storage 161A can be integrated, these read requests are integrated into one request so that the once content reading operation from the storage 161A causes the content 260A read out from the storage 161A for the plurality of read requests to be returned.

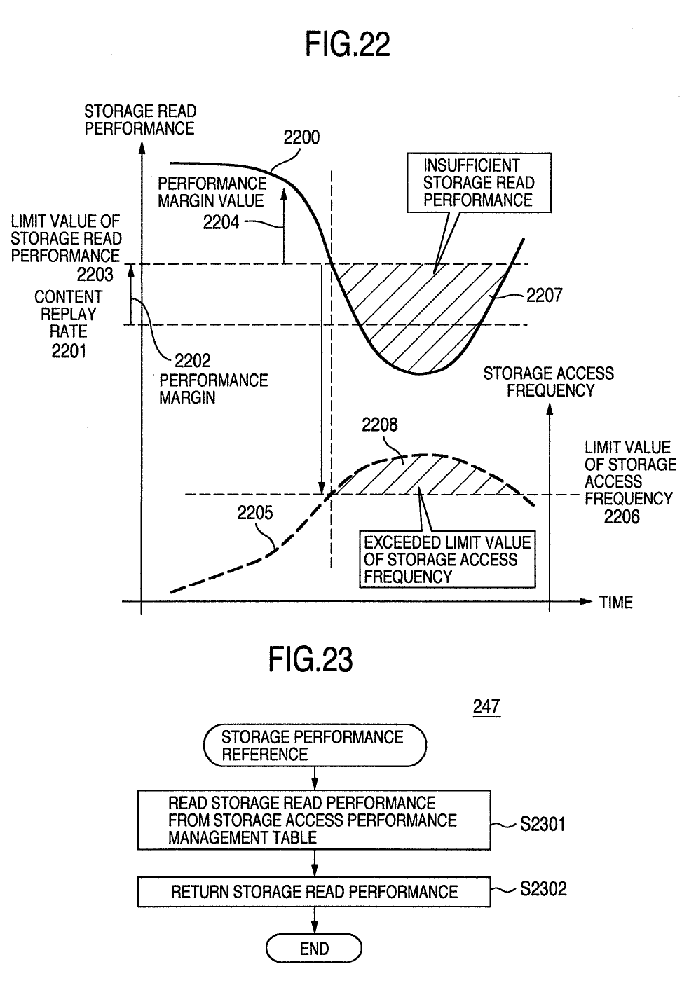

Further, the read control program 243 calculates the storage read performance of the content 260A from the storage 161A and informs the storage performance management program 247 of the calculated result. The storage performance management program 247 compares the storage read performance of the storage 161A informed from the read control program 243 with a predetermined limit value of the storage read performance in the storage 161A. When the storage read performance is not larger than the limit value of the storage read performance, the storage performance management program 247 instructs the cache control program 246 to modify the size of the cache area of the content cache 143 allocated to the content 260A stored in the storage 161A. The limit value of the storage read performance is shown in FIG. 22.

The cache control program 246 modifies the size of the cache area of the storage 161A allocated to each content 260A on the basis of information about access frequencies of all the content 260A stored in the storage 161A in such a manner that the storage read performance of the storage 161A exceeds the limit value of the storage read performance.

Explanation will next be made as to a processing procedure when the content registration program 201 of the client 10 issues a request to the content acceptance program 211 of the media server 11 to register (newly register or updating the registration of) content or delete the content.

When the content registration program 201 of the client 10 issues a content registering or deletion request to the content acceptance program 211, the content acceptance program 211 requires the content management program 212 to register or delete the content instructed by the client 10. In the case of the content deletion or registration update, the content management program 212 acquires a content name as an identifier of the specified content in the file server 14 from the content management table 215. In the case of the content registration, the content management program 212 issues a content registering request to the file server 14 with the registration-target content as an argument, to the content update program 214. In the case of the content deletion, the content management program 212 issues a content deletion request with the content name as an argument from the file server 14 to the content update program 214.

The content update program 214 next issues a content registering or deleting request to the file server 14, to the update request management program 244 of the file server 14. In the case of the content registration or deletion, the update request management program 244 issues a content registering or deleting request to the file system management program 240, and then requires the update control program 245 to register or delete the content. The update control program 245 informs the file system management program 240 and the access frequency management program 242 of the fact of a result of the content registration or deletion, and the update request management program 244 in turn returns the result to the media server 11.

In the case of the deletion, the update control program 245 deletes a content 260B from a storage 161B. In the case of the registration, the update control program 245 determines the storage 161B for the content to be registered on the basis of information about storage read performances and free capacities of storages acquirable by the storage performance management program 247, and performs writing operation on the storage 161B. Further, the update control program 245 requires the cache control program 246 to register the registered content in the content cache 143. The cache control program 246 calculates a cache size to be allocated to the requested content on the basis of the bit rate as attributes of the content and the read performance of the storage storing destination storage read performance, stores the header part of the content cut out from the content with the calculated size in the content cache 143, and updates a cache size 1605 (refer to FIG. 16) and a cache storing destination 1606 (refer to FIG. 16) in the content storing destination management table 248. The content storing destination management table 248 is shown in FIG. 16.

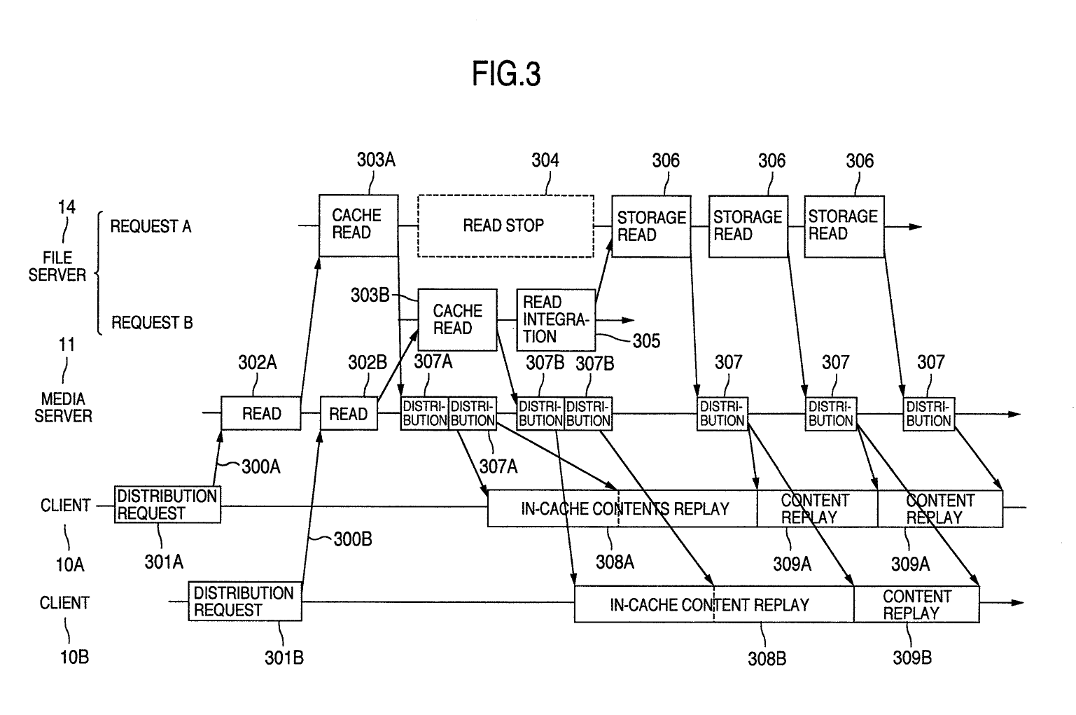

FIG. 3 shows a sequence diagram of content reading and distributing processes in the system.

As has been explained using the module relationship of FIG. 2, distribution requests (read requests) for the same content occurred in predetermined period and issued from a plurality of clients 10 can be integrated into a single storage read request. Explanation will be made in connection with a case when clients 10A and 10B as the clients 10 (refer to FIG. 1) issue distribution requests for the same content in a predetermined period as an example. A sequence 300A is a sequence of a content distribution request 301A from the client 10A, and a sequence 300B is a sequence of a content distribution request 301B from the client 10B. The media server 11, when receiving the distribution requests 301A and 301B, executes content read requests 302A and 302B to the file server 14. The operation for the file server 14 to execute for the distribution request from the client 10A is written in a request A, and the operation for the file server 14 to execute for the distribution request from the client 10B is written in a request B. The file server 14 executes cache reads 303A and 303B to read out the header parts 261 (refer to FIG. 2) of the content stored in the content cache 143 (refer to FIG. 2), and transmits the read-out header part of the content 261 (refer to FIG. 2) to the media server 11.

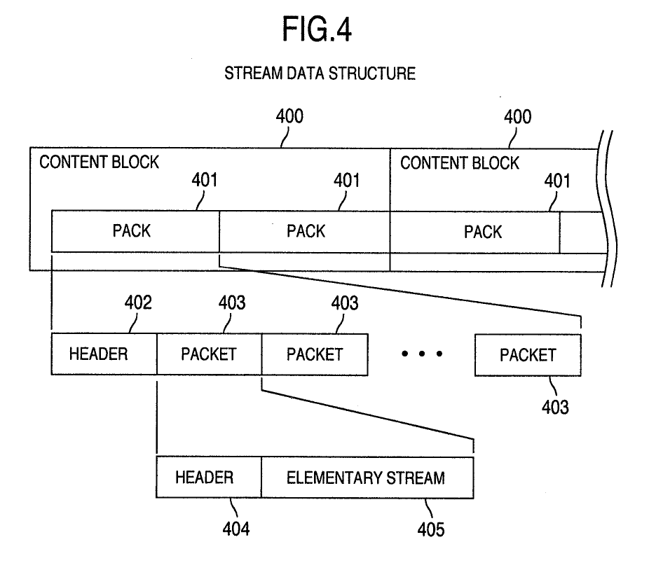

The media server 11 executes distributions 307A and 307B of the read-out content to the clients 10A and 10B. In this case, the media server 11 divides the content read out by the file server 14 with use of the cache reads 303A (303B) into two, and separately distributes the two divided content with use of the distributions 307A (307B). This is because two content blocks 400 (refer to FIG. 4) are included in the header part 261 (refer to FIG. 2) of the content stored in the content cache 143 (refer to FIG. 2). Accordingly, the number of divisions of the content by the media server 11 to separately distributes the divided contents from the media server 11 to the clients 10A and 10B with use of the distributions 307A and 307B is determined by the size of the header part 261 (refer to FIG. 2) of the content stored in the content cache 143 (refer to FIG. 2). The clients 10A and 10B starts replaying the content in the caches with use of in-cache content replays 308A and 308B on the basis of the distributed content. The file server 14 stops reading operation for the content read request 302A with use of a read stop 304. When the content read request B accepted by the file server 14 during the read stop 304 is to read out the same content as the content to be read out for the content read request 302A, the file server 14 integrates the content read request 302B into the content read request 302A with use of a read integration 305. When the read stop 304 is terminated, the file server 14 starts reading the storage with use of a storage read 306. The media server 11 executes the distribution 307 of distributing the content read out by the file server 14 to the client 10A as the issuer of the content read request 302A, and also executes the distribution 307 of distributing the content read out by the file server 14 to the client 10B as the issuer of the content read request 302B (into which the content read request 302A was integrated with use of the read integration 305). The clients 10A and 10B execute content replays 309A and 309B on the basis of the distributed content respectively. Through the above procedure, with use of the single integrated storage read, the obtained content can be distributed to a plurality of the clients 10 (see FIG. 1). With the above arrangement, degradation in the content read performance from the storage caused by access concentration can be prevented.

FIG. 4 is a diagram for explaining a structure of stream data and content blocks. By referring to FIG. 4 (and also to FIG. 1 as necessary) explanation will be made as to the structure of stream data (such as a video stream or a sound stream) as an example of a content.

A content to be distributed in the present system is, for example, stream data based on such a format as MPEG (Moving Picture Experts Group). Stream data has packets 403 as minimum units, and a header 404 and an elementary stream 405 are stored in the packet 403. These packets 403 are combined together with a header 402 into a pack 401. The stream data is distributed in the form of the packs 401 as minimum units. In order for the file server 14 to manage such packs 401, one or a plurality of such packs 401 are combined into management data, which is referred to a content block 400, hereinafter. The media server 11, the file server 14, and the storage server 16 manage the content so as to be able to read and distribute it in units of the content block 400. The distributed content block 400 is decoded by the content replay program 200 of the client 10 which receives the content and replayed on the display unit 104.

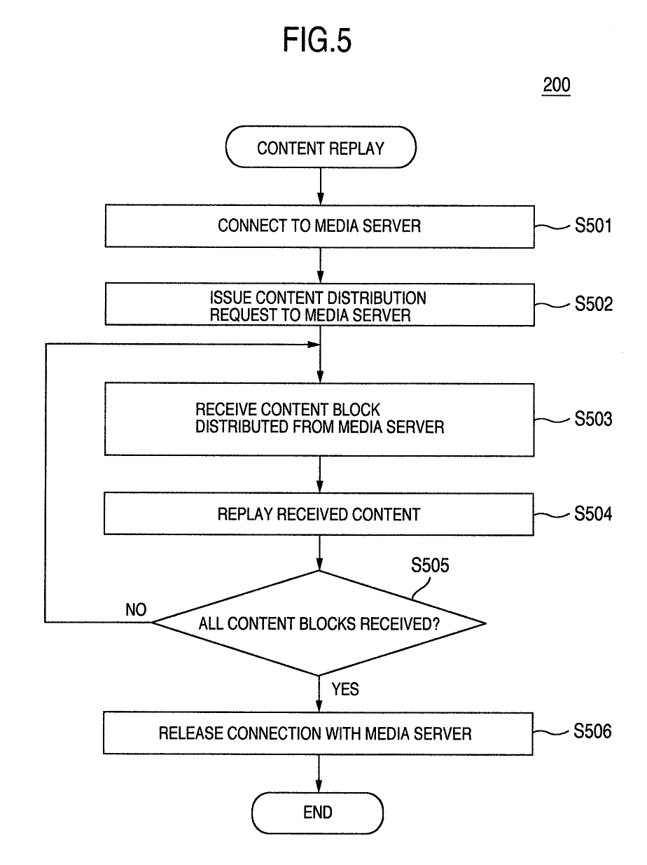

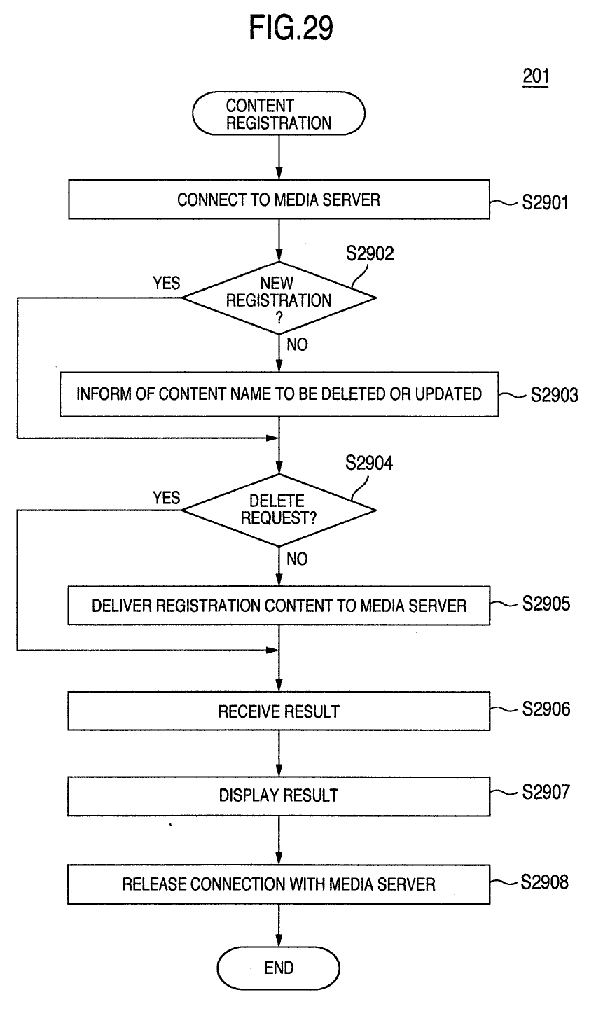

Explanation will be made as to a detailed processing procedure of each program in the client 10, the media server 11, and the file server 14 when the display, registration, update, or deletion of the content is carried out from the client 10. In the explanation, FIGS. 5 to 28 are used to display the content, and FIGS. 29 to 36 (and also the other drawings as necessary) are used to register or delete the content.

FIG. 5 is a flow chart showing an execution procedure of the content replay program 200 in the client 10.

In a step S501, first, the client is connected to the media server 11 according to a protocol provided by the media server 11. In a step S502, the client issues a content distribution request to the media server 11 connected thereto by specifying a unique public content name on the WAN 13. In a step S503, the client waits for the distribution of the content block from the media server 11 and receives the content block distributed therefrom. In a step S504, the client outputs the received content block on the display unit 104 of the client 10 for its replay. In a step S505, the client determines whether or not to have received all the content blocks. When there is yet a content block to be received, the client repetitively executes the steps S503 and S504. When the client finishes the reception of all the content blocks, the client releases (cuts) the connected with the media server 11 in a step S506.

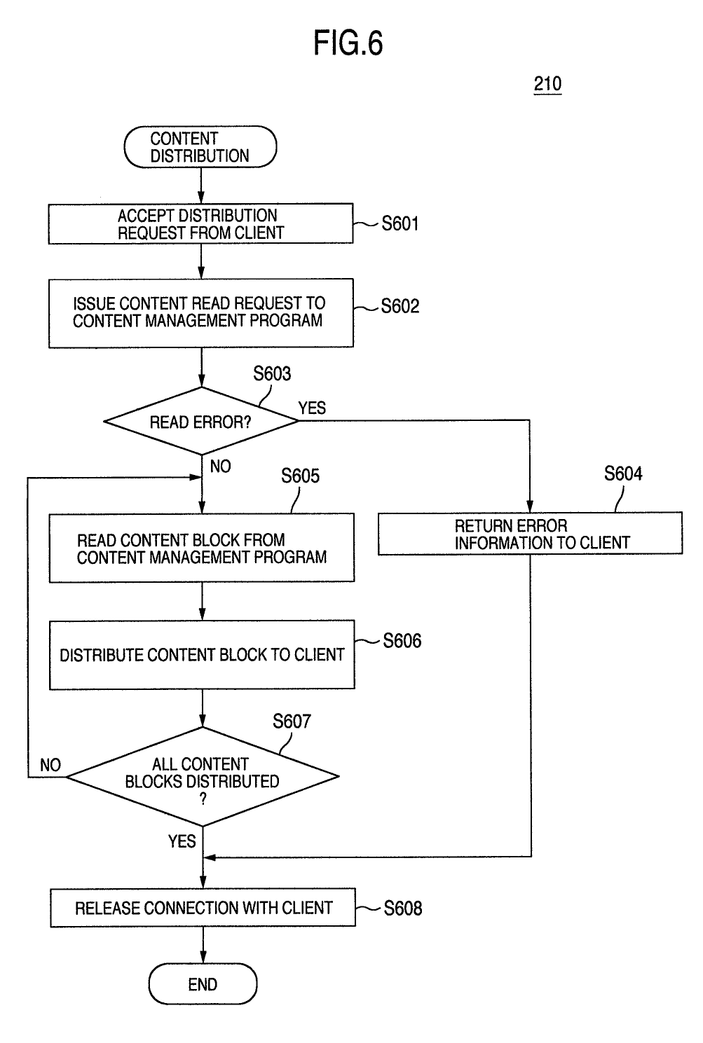

FIG. 6 is a flow chart of operation of the content distribution program 210 in the media server 11.

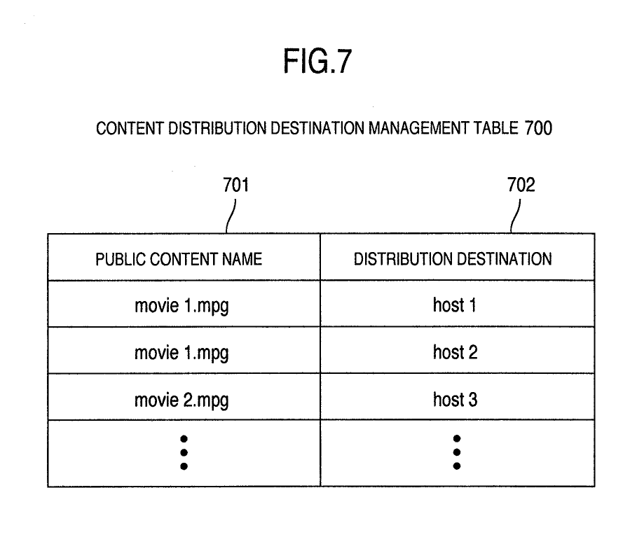

In a step S601, when the media server 11 waits for and accepts a content distribution request from the client 10, the media server records an entry of the accepted distribution request in a content distribution destination management table 700. The data structure of the content distribution destination management table 700 will be explained later by referring to FIG. 7. In a step S602, the media server requires the content management program 212 to read the specified content. In a step S603, checks an execution result of the content management program 212. When an error is returned to the media server when reading the content, the media server informs the client 10 of the error information in a step S604. After the media server informs the client 10 of the error information, the media server releases the connection with the client 10 in a step S608.

When the read error is not returned to the media server in the step S603, the media server waits for the return of the content block from the content management program 212 and reads the returned content block in a step S605. In a step S606, further, the media server distributes the read-out content block to the client 10. In a step S607, the media server determines whether or not to have distributed all the content blocks required by the client 10. When the distribution is not completely finished, the media server repeats the execution of the steps S605 and S606. When finishing the distribution of all the requested content blocks to the client 10, the media server deletes the entry recorded in the content distribution destination management table 700 and releases the connection with the client 10 in the step S608.

FIG. 7 shows a data structure of the content distribution destination management table 700 used by the content distribution program 210 of the media server 11. A public content name 701 and a distribution destination 702 are registered in the content distribution destination management table 700. Stored in the distribution destination 702 is information necessary for the content distribution program 210 to be connected to the client 10. The information necessary for the content distribution program to be connected to the client 10 refers to information for identifying the client 10, such as the title of the client 10, an IP (Internet Protocol) address, or a URL (Uniform Resource Locator).

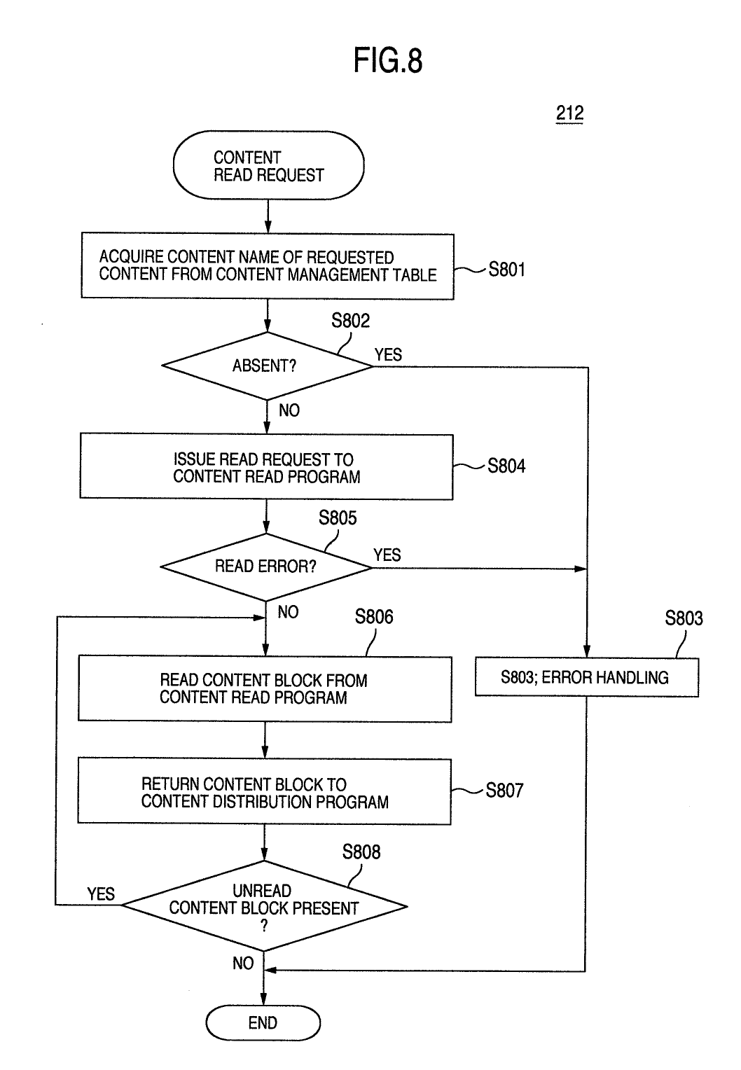

FIG. 8 is a flow chart of a content read request process in the content management program 212 of the media server 11.

When a content read request is issued from the content distribution program 210, the content management program 212 executes the operation or process for the content read request. In the content read request process, content management program acquires, in a step S801, a content name 904 from the content management table 215 as an identifier of the content on the file server 14 required to be read out based on the public content name. The content management table 215 is shown in FIG. 9.

When the content management program determines in a step S802 that the requested content is not present in the content management table 215, the content management program executes an error handling operation in a step S803, and returns an error indicative of the absence of the requested content to the content distribution program 210, and terminates its operation. When determining the presence of the requested content in the content management table 215 in the step S802, the content management program specifies the content name and requires the content read program 213 to read out the content from the file server 14 in a step S804.

When determining that a read error was returned from the content read program 213 in a step S805, the content management program executes the error handling operation, returns an error indicative of the disabled reading of the requested content to the content distribution program 210, and terminates its operation in the step S803. When determining that the content read program 213 successfully read the content in the step S805, the content management program sequentially reads out content blocks returned from the content read program 213 in a step S806, and returns the read-out content blocks to the content distribution program 210 in a step S807. The content management program determines whether or not a content block for the read-target content is left still in a step S808. In the presence of an unread content block, the content management program repeats the operations of the steps S806 and S807. When finishing the reading of all the content blocks, the content management program terminates its operation.

FIG. 9 shows a data structure of the content management table 215 in the media server 11.

Recorded in the content management table 215 are public content name 901 as an identifier for the client 10 to identify a content in the media server 11, a file type 902 for the content (such as information for identifying the structure of the stream data shown in FIG. 4), a bit rate 903 of the stream data of the content, and a content name 904 as an identifier for identifying the content stored in the file server 14.

An entry for this table is created upon a content registering request to the media server 11, and is deleted upon a content deletion request. The public content name 901 is provided so as to be unique in the media server 11 upon content registration. Values acquired from attribute information about the registered content are stored for the file type 902 and the bit rate 903. Although the attribute information is, for example, a value set in the header 402 of the registered content, the file type 902 is not indispensable. Stored in the content name 904 is information (such as a character string) given as a unique identifier in the file server 14 upon the content registration to the file server 14.

FIG. 10 is a flow chart of operation of the content read program 213 in the media server 11.

In a step S1001, the content read program specifies a content name passed as an argument upon content read request from the content management program 212, and issues a content read request to the read request management program 241 of the file server 14. When determining in a step S1002 that a content read became an error in the file server 14, the content read program executes an error handling operation in a step S1003. In the error handing operation of the step S1003, the content read program returns a read error to the content management program 212.

When determining that the content read is successful in the step S1002, the content read program sequentially reads content blocks from the file server 14 in a step S1004, and returns the read-out content blocks to the content management program 212 in a step S1005. The content read program checks in a step S1006 whether or not a remaining content block not read out yet is still present. So long as a content block for the read target content exists, the content read program repeats the execution of the steps S1004 and S1005. After the content read program returns all the content blocks to the content management program 212 or finishes the error handling operation of the step S1003, the program terminates its operation.

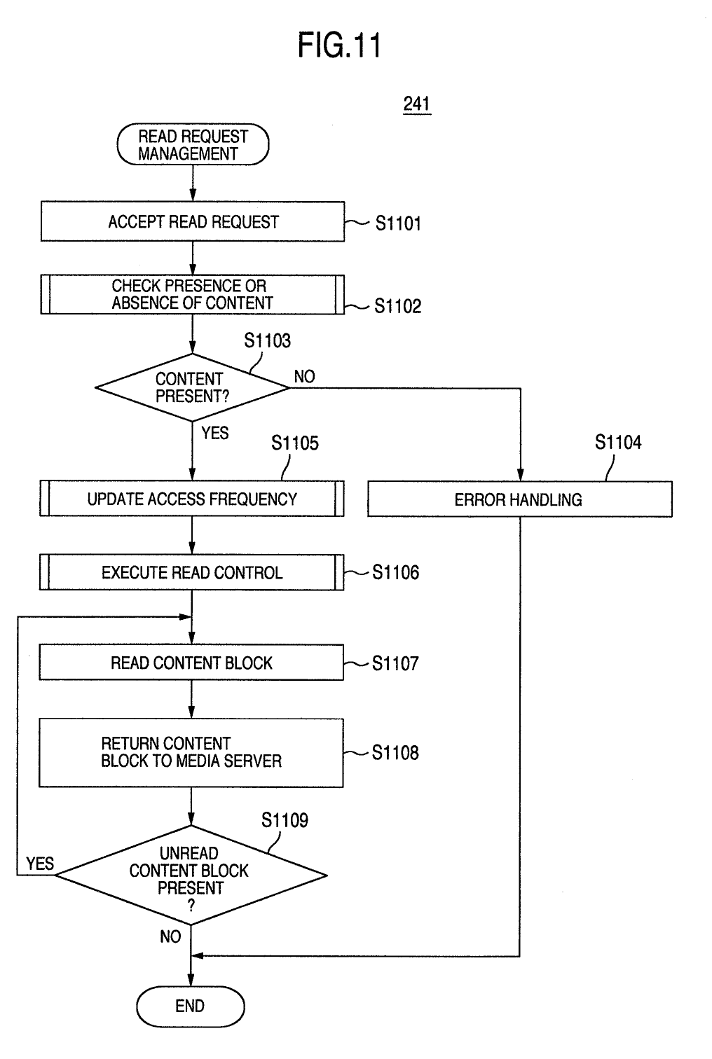

FIG. 11 is a flow chart of operation of the read request management program 241 in the file server 14.

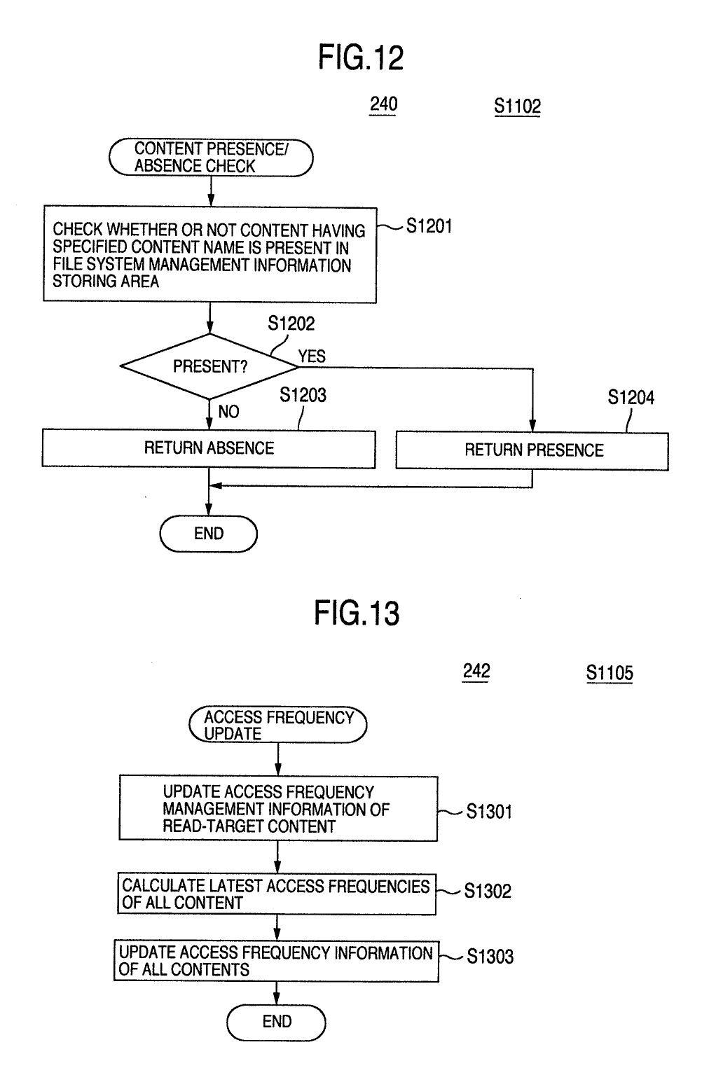

When the read request management program waits for a read request from the media server 11 and accepts it in a step S1101, the read request management program acquires a content name passed as an argument. The read request management program requires the file system management program 240 to check whether or not a content corresponding to the content name is present in a step S1102. The content absence/presence check operation of the file system management program 240 will be explained later with use of FIG. 12.

When determining in a step S1103 that a content corresponding to the content name is absent, the read request management program executes the error handling operation of a step S1104. In the error handling operation of the step S1104, the read request management program returns an error indicative of the unsuccessful reading of the content to the media server 11. When determining in the step S1103 that a content corresponding to the content name is present, the read request management program issues an access frequency information update request to the content to the access frequency management program 242 in a step S1105. The updating operation of the access frequency information in the access frequency management program 242 will be explained later by using FIG. 13.

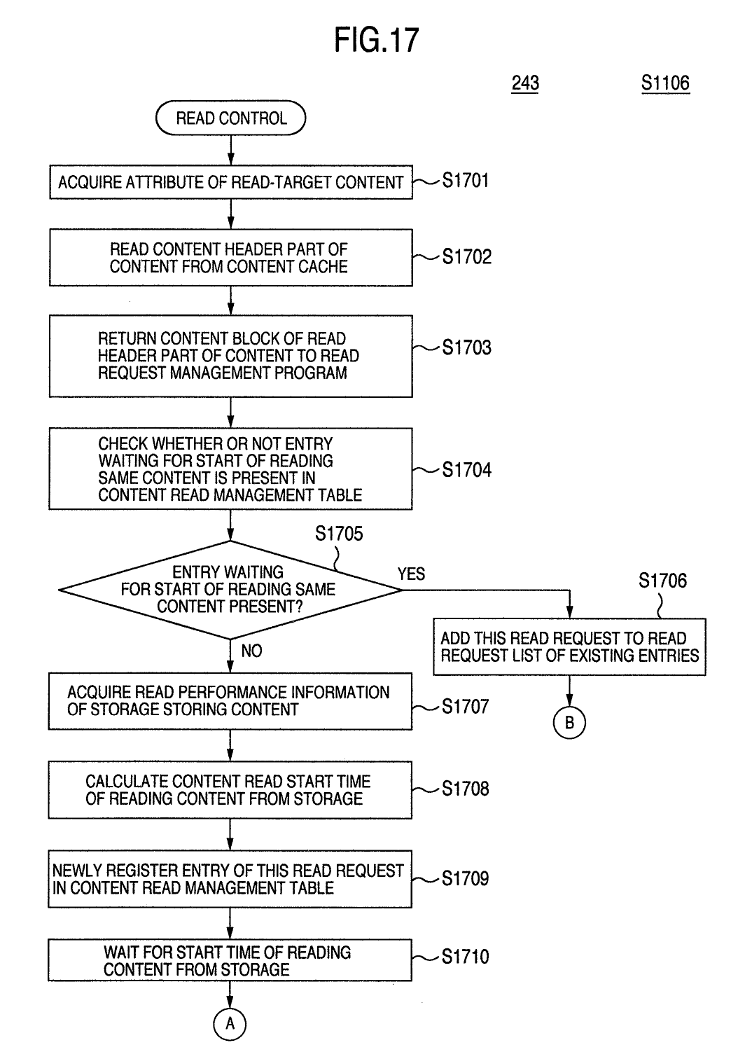

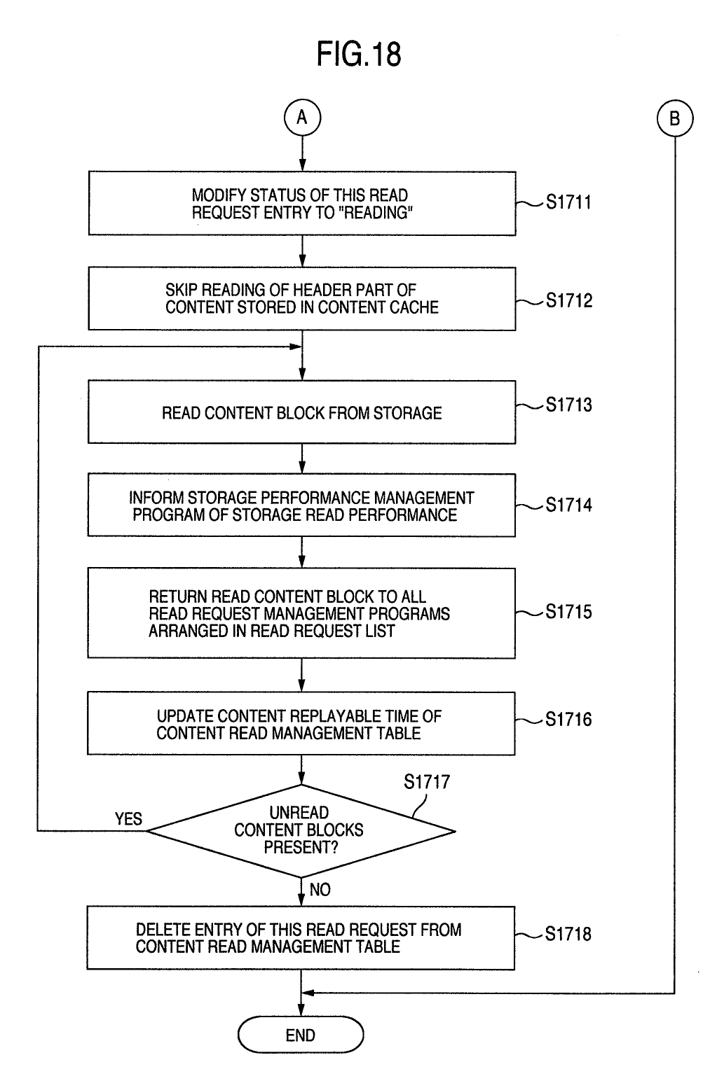

In a step S1106, next, the read request management program executes the read control program 243 by specifying the content name. The processing procedure of the read control program 243 will be explained later by using FIGS. 17 and 18. The read request management program sequentially reads out content blocks under control of the read control program 243 in a step S1107, and returns the read-out content blocks to the media server 11 in a step S1108. When determining in a step S1109 that a content block is still left, the read request management program repeats the operations of the steps S1107 and S1108. When read request management program determines in the step S1109 that all the content blocks were returned to the media server 11 or when the read request management program completes the error handling operation of the step S1104, the read request management program terminates its operation.

FIG. 12 is a flow chart of the operation of the content absence/presence checking process of a step S1102 in the file system management program 240 of the file server 14.

When the file system management program 240 is required to check the absence or presence of a content by specifying the content name, the file system management program checks whether or not a content corresponding to the specified content name is present in the management information storing area 249 in a step S1201. When determining the absence of the corresponding content in a step S1202, the file system management program returns a return value (indicative of the absence of the specified content) in a step S1203. When determining the presence of the specified content in the step S1202, the file system management program returns a return value (indicative of the presence of the specified content) in a step S1204. After returning the result, the file system management program terminates its operation.

FIG. 13 is a flow chart of an access frequency updating process S1105 in the access frequency management program 242 of the file server 14.

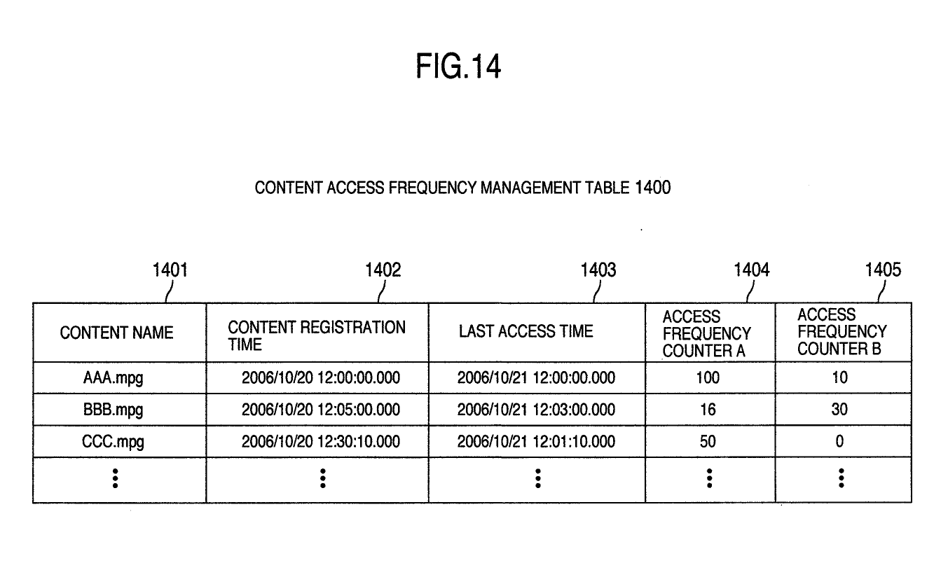

In a step S1301, the access frequency management program updates access frequency management information about a content to be read out as a target. In other words, the access frequency management program updates (increments by 1) the value of an access frequency counter A 1404 or of an access frequency counter B 1405 with respect to an entry which is stored in a content access frequency management table 1400 of FIG. 14 and which corresponds to the specified content name, and also updates a last access time 1403 to the current time.

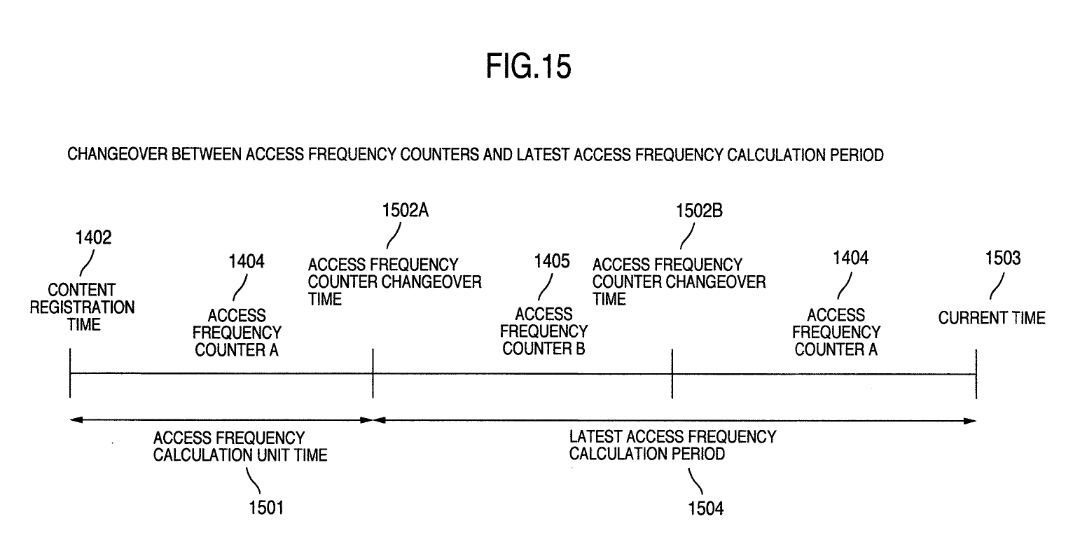

In a step S1302, the access frequency management program calculates newest access frequencies of all the content with use of a content registration time 1402, the access frequency counter A 1404, the access frequency counter B 1405, and the current time upon execution, all managed in the content access frequency management table 1400. How to calculate access frequencies from information stored in the content access frequency management table 1400 will be explained later by using FIG. 15. In a step S1303, the access frequency management program updates information about access frequencies of all the contents calculated in the step S1302. That is, the calculated information is stored in an access frequency 1604 of the content storing destination management table 248. At this stage, the access frequency management program terminates its operation.

FIG. 14 shows a data structure of the content access frequency management table 1400 used by the access frequency management program 242 of the file server 14.

Stored in the content access frequency management table 1400 are a content name 1401, a content registration time 1402, a last access time 1403, and two counters of the access frequency counter A 1404 and the access frequency counter B 1405. In the content registration mode, an entry having the content name 1401 and the content registration time 1402 both set is recorded and the other values are initialized. Each time that a read request takes place for a content, the value stored in either one of the access frequency counters A and B 1404 and 1405 is incremented by 1, and the last access time 1403 is updated to the current time.

FIG. 15 is a diagram for explaining a method of determining an access frequency counter and a method of calculating a latest access frequency used in the content access frequency management table 1400 in the access frequency management program 242 of the file server 14.

One of the two counters of the access frequency counters A 1404 and B 1405 to be used is determined by the content registration time 1402, a current time 1503 at the time of access frequency update execution, and a predetermined access frequency calculation unit time 1501. Until an access frequency counter changeover time 1502A elapsed by the access frequency calculation unit time 1501 after the content registration, the access frequency counter A 1404 is used. Until an access frequency counter changeover time 1502B after the access frequency counter changeover time 1502A, the access frequency counter B 1405 is used. Thereafter, each time that the access frequency counter changeover time 1502 elapses, changeover is made between the access frequency counters A 1404 and B 1405.

Upon the first read request after the access frequency counter changeover time 1502A, 1502B, the used access frequency counter is initialized to 0. Upon the first read request to the content after the access frequency counter changeover time 1502A, for example, the access frequency counter A 1404 is initialized to 0. Upon the first read request to the content after the access frequency counter changeover time 1502B, the access frequency counter B 1405 is initialized to 0. Whether or not the read request is the first read request after the access frequency counter changeover time 1502A, 1502B is determined by whether or not the last access time 1403 is earlier than the latest access frequency counter change time 1502B. When the last access time 1403 is earlier by 2 than the access frequency counter change time 1502A, both of the access frequency counters A 1404 and B 1405 are initialized to 0.

A latest access frequency of each content is calculated as an access frequency per unit time (e.g., per one minute) according to an equation which follows, with use of the access frequency counter A 1404, the access frequency counter B 1405, and a latest access frequency calculation period 1504 as a time difference (e.g., a time difference per minute) between the current time 1503 and the access frequency counter changeover time 1502A previous by 2.

Latest access frequency={(value of access frequency counter A+(value of access frequency counter B)) divided by (latest access frequency calculation period)

Although two of the access frequency counters have been used for simplicity of explanation, 3 or more of the access frequency counters may be employed.

FIG. 16 shows a data structure of the content storing destination management table 248 in the file server 14.

A content name 1601, a content size 1602, a content bit rate 1603 as stream data, a latest access frequency 1604 of the content, a cache size 1605 as the size of the header part of the content stored in the content cache 143, a cache storing destination 1606 as a storing destination in the header part of the content in the content cache, and a storage storing destination 1607 are recorded in the content storing destination management table 248 as its entries. As a value set at the cache storing destination 1606, the header address of the header part of the content in the content cache as an example may be used. As a value set at the storage storing destination 1607, a storage number or the header address of the content in the storage as an example may be used.

FIG. 17 shows a first part of a flow chart of operation of the read control program 243 in the file server 14.

In a step S1701, when the read control program accepts a read request with a content name as an argument from the read request management program 241, the read request management program acquires attribute information on the read-target content stored in the content storing destination management table 248. The word ‘attribute information’ is an entry obtained by searching the content storing destination management table 248 for the content name 1601 which coincides with the content name of the argument.

In a step S1702, the read control program reads out the header part 261 of the content stored in the content cache 143 on the basis of the size (cache size 1605) of the header part of the content stored in the content cache 143 and a storing destination (cache storing destination 1606) of the header part of the content in the content cache 143 among the attribute information read out in the step S1701.

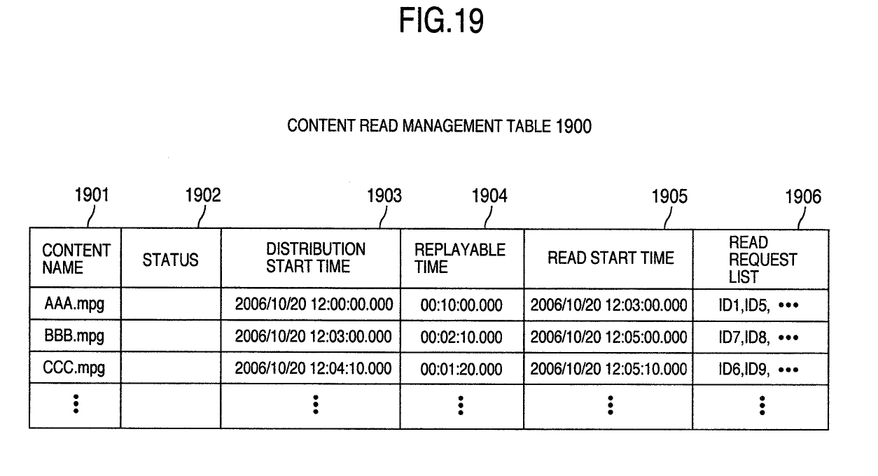

In a step S1703, the read control program returns the read-out header part 261 per unit of the content block to the read request management program 241. In a step S1704, the read control program checks whether or not an entry having the same content name 1901 as the content name of the specified argument and having a status 1902 of “read waiting” is present in a content read management table 1900 shown in FIG. 19.

When the read control program determines in a step S1705 that an entry of the status “read waiting” from the storage 161 is present for the same content, the read control program adds an identifier for identifying a process of the read request management program 241 in a read request list 1906 in this entry and terminates the operation of controlling the reading operation for this read request in a step S1706 (refer to FIG. 18).

When the read control program determines in the step S1705 that an entry of the status “read waiting” from the storage 161 is not present for the same content, the read control program acquires read performance information about the storage 161 having the content stored therein obtained from the storing destination (storage storing destination 1607) in the storage recorded in the content storing destination management table 248 in a step S1707. This read performance information can be acquired, for example, from a storage read performance 2200 in a storage access performance management table 2100.

In a step S1708, the read control program first finds a time necessary for reading out the content block of a read-target content 260 from the storage 161 on the basis of the read performance information about the storage 161 obtained in the step S1707, and further finds a replay time based on the header part 261 of the content returned in the step S1703 by dividing the size of the header part 261 of the content by the bit rate 1603 of the content. A time calculated by adding a difference between aforementioned two times to the time obtained in the step S1703 when the header part of the content 261 is returned is used as a content read start time from the storage.

In a step S1709, a new entry is recorded in the content read management table 1900 by the read control program, which sets the content name of the read-target content for a content name 1901, sets “read waiting” for the status 1902, sets a time when the distribution of the header part 261 of the content stored in the content cache 143 is started for a distribution start time 1903, sets a replay time calculated by dividing the size of the header part of the content 261 by the bit rate of the content for a replayable time 1904, sets a content read start time from the storage calculated in the step S1708 for a read start time 1905 from the storage, and sets an identifier for identifying an execution process of the read request management program 241 for the read request list 1906. In a step S1710, the read control program waits until the read start time 1905 to start reading content from the storage.

FIG. 18 is the remaining part of the flow chart of operation of the read control program 243 in the file server 14.

In a step S1711, the read control program changes the status 1902 recorded in the content read management table 1900 to “reading” at the read start time 1905. In a step S1712, since the header part 261 of the content stored in the content cache 143 among the content 260 stored in the storage 161 is already read out from the content cache 143, the read control program skips this header part when reading out the content 260 stored in the storage 161.

In a step S1713, the read control program reads out the content block from the storage 161. When reading out the content block from the storage 161, the read control program starts reading out the content block on the basis of the storage storing destination 1607 of the attribute information acquired in the step S1701, and thereafter sequentially reads out it. When the read control program performs a plurality of reads on one or a plurality of contents stored in one storage 161, the read control program preferentially executes one of the reads corresponding to shortest one of times obtained by subtracting the current time from replay completion times corresponding to additions of the replayable times 1904 to the distribution start times 1903 in the content read management table 1900 (preferentially executes the earliest read). When the read control program preferentially reads out the content having the earliest replay completion time, the replay of the other contents caused by the read delay of the specific content can be prevented from being stopped. In a step S1714, the read control program calculates a read-out performance of the storage 161 from a time necessary for reading out the content block from the storage 161, and informs the storage performance management program 247 of the calculated result.

In a step S1715, the read control program returns the content block read out from the storage 161 to the processes of all the read request management programs 241 arranged in the read request list 1906 of the content read management table 1900. In a step S1716, the read control program updates the replayable time 1904 by adding the replayable time of the returned content to the replayable time 1904 of the content read management table 1900. In a step S1717, the read control program determines whether or not an unread content block is present. In the presence of an unread content block, the read control program repeats the operations of the steps S1713, S1714, S1715, and S1716. When determining in a step S1717 that all the content blocks have been returned, the read control program deletes the entry of this read request recorded in the content read management table 1900 and terminates its operation in a step S1718.

FIG. 19 shows a data structure of the content read management table 1900 used by the read control program 243 of the file server 14.

Recorded in the content read management table 1900 are entries of the content name 1901, the status 1902 of read from the storage, the distribution start time 1903, the replayable time 1904, the read start time 1905 from the storage, and the read request list 1906.

The status 1902 of read from the storage has “read waiting” and “reading”. The distribution start time 1903 is a time when the distribution of the header part of the content 261 is started. The replayable time 1904 is a time during which the already distributed contents can be replayed. Stored in the read start time 1905 from the storage is a read start time calculated in the step S1708 of the flow chart of the read control program 243 shown in FIGS. 17 and 18. Stored in the read request list 1906 is a list of identifiers for identifying the execution process of the read request management program 241 which called the read control program 243.

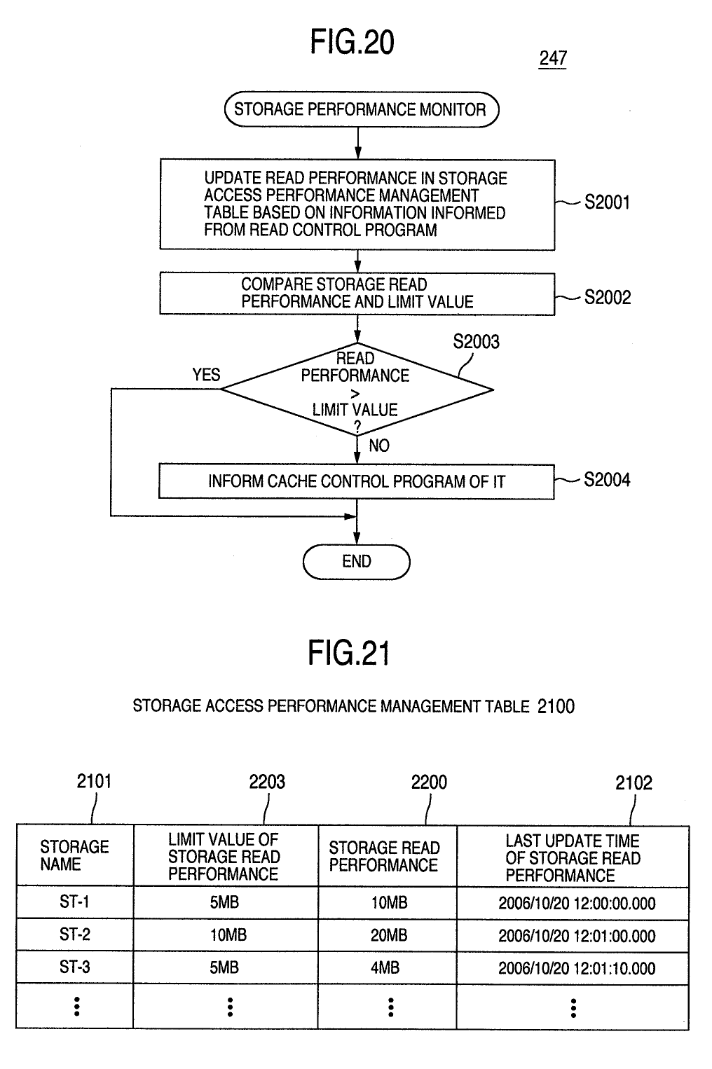

FIG. 20 is a flow chart of a storage performance monitoring process in the storage performance management program 247 of the file server 14.

In a step S2001, the storage performance management program records the read-out performance of the content block from the storage 161 informed the storage performance management program 247 in the storage read performance 2200 of the storage access performance management table 2100 shown in FIG. 21 in the step S1714 of the flow chart of the read control program 243 shown in FIGS. 17 and 18. In a step S2002, the storage performance management program compares the storage read performance 2200 and the limit value of the storage read performance 2203. When the storage performance management program determines in a step S2003 that the storage read performance 2200 is not larger than the limit value of the storage read performance 2203, the storage performance management program informs the cache control program 246 of the fact that the storage read performance 2200 is insufficient in a step S2004.

FIG. 21 shows a data structure of the storage access performance management table 2100 used by the storage performance management program 247 of the file server 14.

Stored in the storage access performance management table 2100 are a storage name 2101, a limit value of a storage read performance 2203, a storage read performance 2200, and a last update time of a storage read performance 2102. The limit value of the storage read performance 2203 will be explained by using FIG. 22. The last update time of the storage read performance 2102 is not indispensable.

FIG. 22 shows how to calculate a limit value of a storage read performance based on a content replay rate and also shows a relationship between a change in storage read performance with time and a limit value of a storage access frequency.

The storage read performance 2200 shows a change in the read-out performance of the content block from the storage 161 with time passage. A content replay rate 2201 is the maximum value of replay rate (bit rate) of the content stored in the storage 161. The limit value of the storage read performance 2203 is a performance corresponding to an addition of a performance margin 2202 to the content replay rate 2201.

Set in the performance margin 2202 is, for example, a value found on the basis of the maximum value of an increasing rate of a storage access frequency 2205 per unit time to the storage 161. Thus the content read rate can be set so as to exceed the content replay rate 2201 during a time after the storage performance management program 247 detects that the network monitoring program 220 became not larger than the limit value of the storage read performance 2203 until the cache control program 246 takes a measure to enhance the performance by changing the cache size. When the operation is started, for example, a fixed value may be set at the performance margin 2202 and the value may also be suitably modified.

A performance margin value 2204 is a value obtained by subtracting the limit value of storage read performance 2203 from the storage read performance 2200. The storage access frequency 2205 is a content block reading frequency per unit time to the storage 161. When the storage access frequency 2205 increases and it reaches a certain time point, the storage read performance 2200 is abruptly decreased. When the performance margin value 2204 is zero, the storage access frequency 2205 has a limit value of a storage access frequency 2206. As the performance margin value 2204 is decreased down to zero, the storage read performance 2200 becomes not larger than the limit value of the storage read performance 2203 and the storage read performance becomes insufficient (as shown by reference numeral 2207). At this time point, the storage access frequency 2205 is not smaller than the limit value of the storage access frequency 2206 and thus the storage access frequency exceeds its limit value (as shown by reference numeral 2208). Under this condition, the content replay at the client 10 is stopped by the distribution delay of the content block.

FIG. 23 is a flow chart of a storage performance referring process in the storage performance management program 247 of the file server 14.

In a step S2301, when receiving a storage performance reference request, the storage performance management program acquires read performances of all the storages from the storage access performance management table 2100. In a step S2302, the storage performance management program returns the read-out storage read performances to the requester.

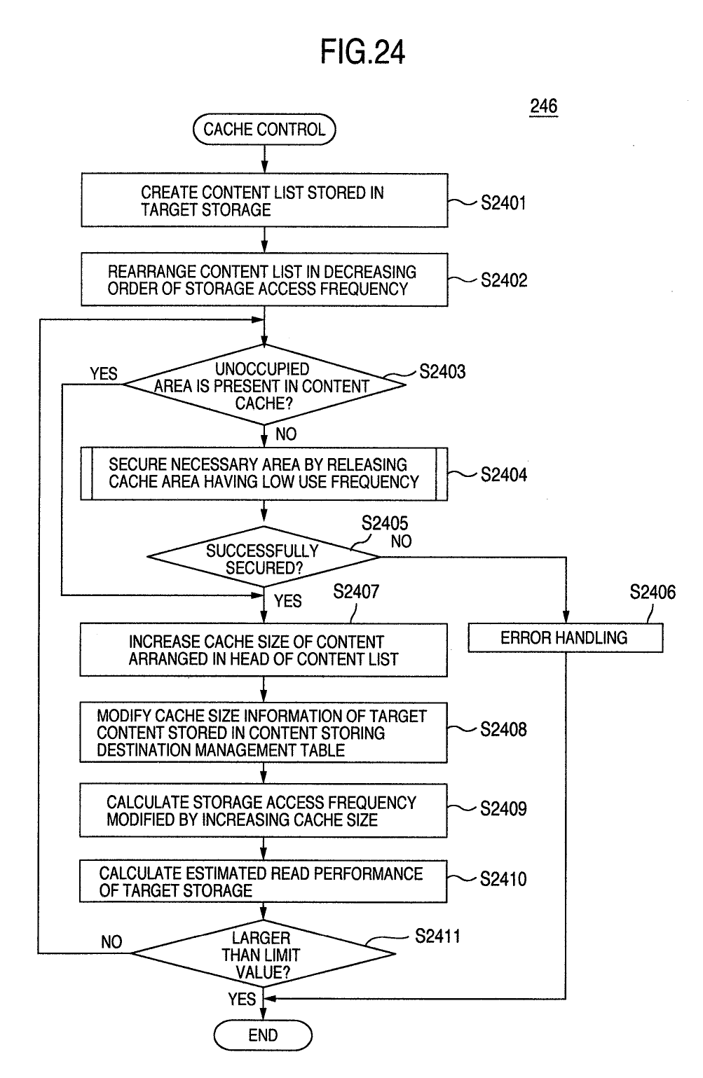

FIG. 24 is a flow chart of operation of the cache control program 246 in the file server 14.

In a step S2401, when the cache control program receives a notification telling the presence of the storage 161 having the performance not larger than the limit value of the storage read performance 2203 from the storage performance management program 247, the cache control program creates a content list of entries of all the content stored in the storage 161 and acquired from the content storing destination management table 248. In a step S2402, when the cache control program first finds a storage access frequency as an access frequency to the content 260 in the storage 161 on the basis of the cache size allocated to each content, the size of the content, and the access frequency of the content. The storage access frequency can be found according to an equation which follows.

Storage access frequency=(access frequency)×(content size−cache size) divided by (cache size)

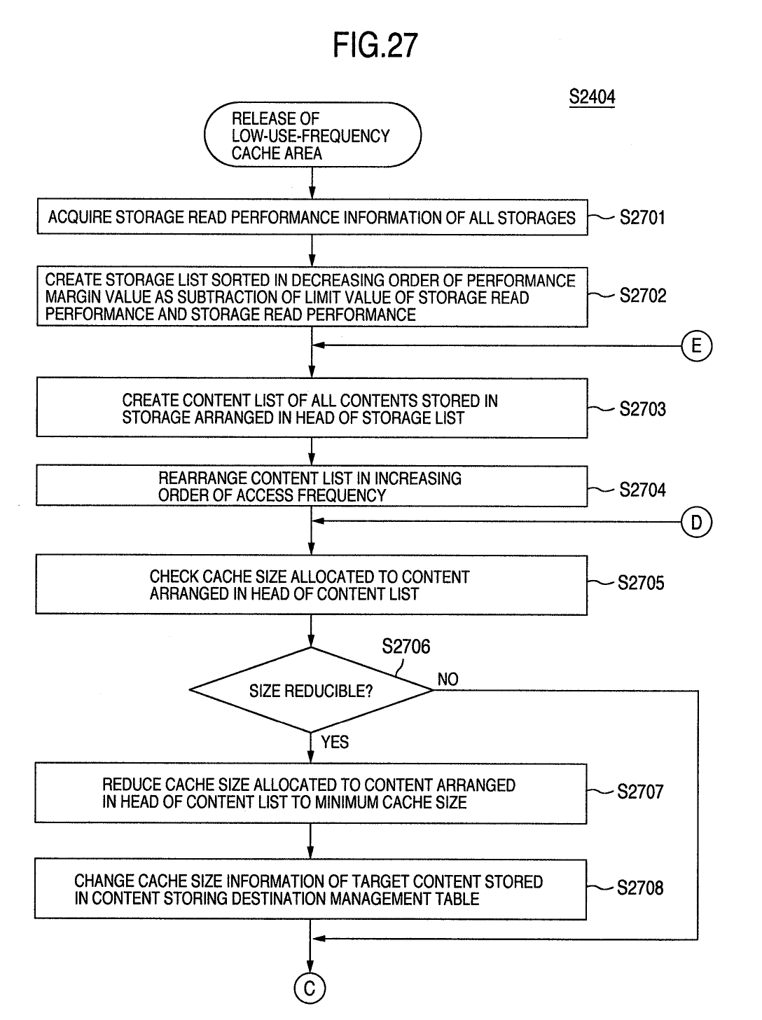

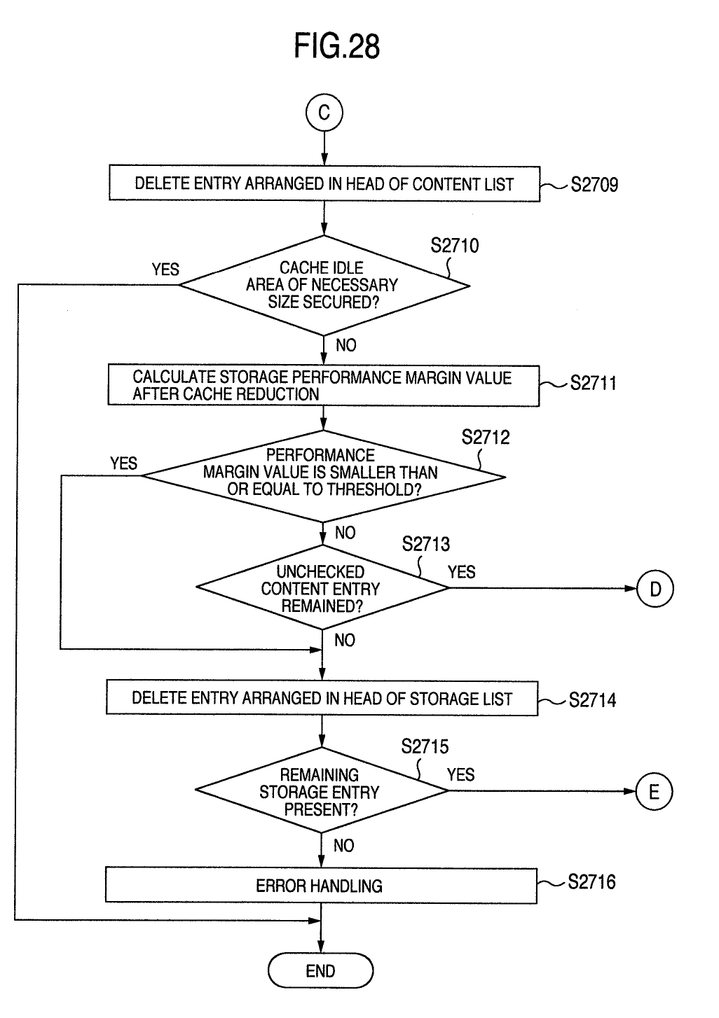

After finding storage access frequencies for all the contents of the content list, the cache control program rearranges the content list in a decreasing order of the storage access frequencies (sorts the content list in a decreasing order of the storage access frequencies). In a step S2403, the cache control program checks whether or not an unoccupied area larger than the size of the content block is present in the content cache 143. When no unoccupied area is present in the content cache 143, the cache control program frees or releases the cache area allocated to the content having a low use frequency to secure a necessary area, that is, an unoccupied area in the content cache 143 in a step S2404. A procedure of releasing the cache area allocated to the content having the low use frequency will be explained later by referring to FIGS. 27 and 28.

In a step S2405, the cache control program checks the a result of the cache area security and determines a failure in the security, the cache control program performs an error handling operation such as issuance of an alert indicative of insufficient cache in a step S2406 and terminates its operation. When determining that an unoccupied area of the content cache 143 was successfully secured in a step S2405, the cache control program increases the size of the cache area of the header part 261 of the content (having a high storage access frequency) arranged in the head of the content list to be stored in the content cache 143 by a size corresponding to one content block, reads out the content block at the header part 261 of the size-increased content from the content 260 stored in the storage 161, and then stores the read-out content block in the content cache 143 in a step S2407.

In a step S2408, the cache control program changes the value of the cache size 1605 of the target content stored in the content storing destination management table 248 to the increased cache size. In a step S2409, the cache control program calculates a storage access frequency of the storage 161 changed by increasing the cache size allocated to the content having a high access frequency in the step S2407, and calculates an estimated storage read performance of the storage 161 on the basis of the calculated storage access frequency in a step S2410.

When the cache control program determines that the calculated estimated storage read performance is not larger than the limit value of the storage read performance 2203 in a step S2411, the program returns to the step S2403, and repeats the aforementioned operations until the storage read performance 2200 exceeds the limit value of the storage read performance 2203. When determining in the step S2411 that the storage read performance exceeds the limit value of the storage read performance, the cache control program terminates its operations.

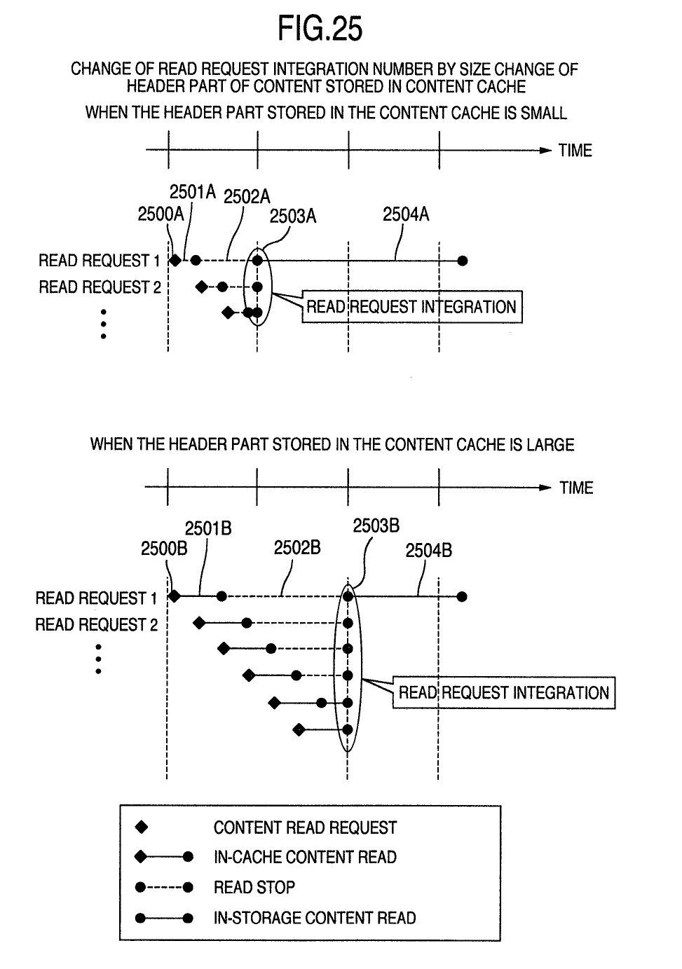

FIG. 25 is a diagram for explaining a change of the request integration number caused by the change of the size of the header part 261 of the content stored in the content cache 143.

In the presence of a content read request 2500A or 2500B, the read control program 243 executes a content read 2501A or 1501B in the cache, after which the read control program enters into a read stop 2502A or 1502B. After the read stop 2502A or 2502B, the read control program 243 executes a read request integration 2503A or 2503B and an in-storage content read 2504A or 2504B.

This drawing compares the content read request 2500A when the cache is small and the content read request 2500B when the cache is large. The execution time of the content read 2501A in the cache is shorter than the execution time of the content read 2501B in the cache, but even the time of the read stop 2502A is shorter than the time of the read stop 2502B. Thus, even when the access frequencies of the contents are the same, the number of read requests which can be integrated into the read request integration 2503A becomes smaller than the number of read requests which can be integrated into the read request integration 2503B. In this way, when the size of the header part 261 of the content stored in the content cache 143 is increased, the read request integration number can be increased and the storage access frequency can be reduced. When the storage access frequency is decreased, the storage read performance is increased.

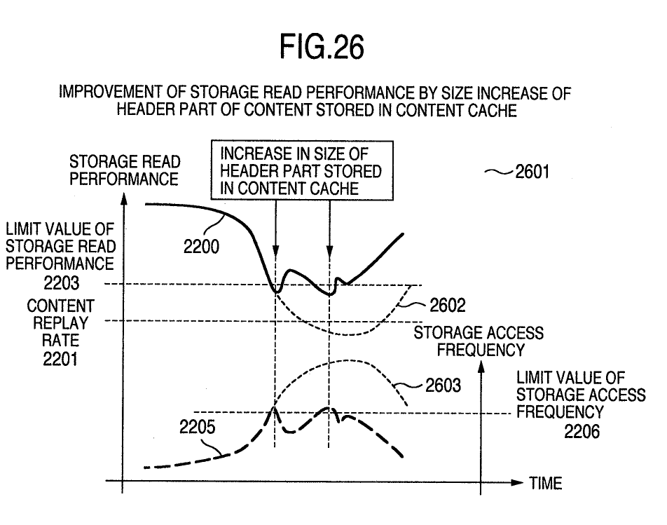

FIG. 26 is a diagram for explaining an increase in the storage read performance caused by an increase in the size of the header part 261 of the content stored in the content cache 143.

When the storage read performance 2200 fails to exceed the limit value of the storage read performance 2203 calculated by using the content replay rate 2201, even the storage access frequency 2205 is equal to or larger than the limit value of the storage access frequency 2206. At this time, the cache control program 246 increases the size of the header part 261 of the content stored in the content cache 143, the storage access frequency 2205 is decreased to thereby increase the storage read performance 2200. When the operation of the cache control program 246 is executed to carry out a content cache storing size increase 2601 each time that the storage read performance 2200 becomes not larger than the limit value of the storage read performance 2203, the storage read performance 2200 can be kept at a value higher than the content replay rate 2201. A storage read performance 2602 when the content cache storing size increase 2601 is not carried out, becomes not larger than the content replay rate. Even a storage access frequency 2603 when the content cache storing size increase 2601 is not carried out becomes not smaller than the limit value of the storage access frequency 2206.

FIG. 27 shows a first part of a flow chart of a process of releasing a cache area having a low use frequency in the cache control program 246 of the file server 14. This flow chart shows a processing procedure of the step S2404 of FIG. 24 in the flow chart of the cache control program 246 in the file server 14. This procedure is called when the cache control program 246 increases the size of the cache area allocated to the content having a high storage access frequency and when the size of an unoccupied area of the content cache 143 is insufficient.

In a step S2701, the cache control program acquires the storage read performances 2200 of all the storages 161 from the storage access performance management table 2100 shown in FIG. 21, and creates a storage list. In a step S2702, the cache control program sorts the storage list in a decreasing order of the performance margin value 2204 as a subtraction of the limit value of the storage read performance 2203 from the storage read performance 2200. As a result, the storage list is created in a decreasing order of the storage read performance margin.

In a step S2703, the cache control program creates a content list of entries of all contents stored in the storage 161 arranged in the head of the created storage list and acquired from the content storing destination management table 248. In a step S2704, the cache control program sorts all the contents stored in the content list in an increasing order of the access frequency 1604. As a result, a content list having the contents arranged in an increasing order of the access frequency is created.

In a step S2705, checks the cache size 1605 allocated to the content 260 arranged in the head of the content list. That is, the cache control program checks whether or not this cache size is larger than a size (minimum cache size) storable at the header part 261 allowing the replay for a time necessary for reading out the minimum unit (one content block unit) of the content blocks from the storage 161 having the content 260 stored therein. The minimum cache size is calculated, for example, by multiplying a time necessary for reading out the minimum unit of the content blocks by the bit rate of the content.

When the cache size is larger than the minimum cache size, the cache size allocated to the content can be reduced. When the cache control program in a step S2706 that the cache size 1605 can be reduced, the cache control program reduces the size of the header part 261 of the content stored in the content cache 143 down to the minimum cache size in a step S2707. In a step S2708, the cache control program changes the cache size 1605 of the target content stored in the content storing destination management table 248 to the reduced size. When determining in the step S2706 that the cache size has such a size as not to be able to be reduced, the cache control program skips the steps S2707 and S2708.

FIG. 28 shows the remaining part of the flow chart of the process of releasing a cache area having a low use frequency in the cache control program 246 of the file server 14.

In a step S2709, the cache control program deletes the first entry from the content list. When determining the secured unoccupied area of a necessary size in the content cache 143 in a step S2710, the cache control program terminates its operation. When determining a failure in the security of a necessary unoccupied area in the content cache 143 in the step S2710, the cache control program continues to perform the operation of releasing the cache area allocated to the content having a low storage access frequency in order to secure an additional necessary cache area.

In a step S2711, the cache control program calculates an estimated value of the storage read performance 2200 of the storage 161 arranged in the head of the storage list caused by an increase in the storage access frequency of the content with the reduced cache size, and also calculates the performance margin value 2204 as a subtraction of the limit value of the storage read performance 2203 from it.

When determining in a step S2712 that the calculated performance margin value 2204 became not larger than a predetermined threshold, the cache control program terminates the releasing operation of the cache area allocated to the content 260 stored in the storage 161, and then performs the operations of a step S2714 and subsequent steps.

When determining in the step S2712 that the calculated performance margin value 2204 exceeds the threshold, the cache control program checks in the step S2713 the presence or absence of a unchecked entry in the content list. In the presence of an entry, the cache control program returns to the operation of the step S2705 and continues to reduce the cache size allocated to the content of the next entry.

When determining in the step S2713 the absence of an entry in the content list, the cache control program terminates the reducing operation of the cache size to the content 260 stored in the storage 161, and performs the operations of the step S2714 and subsequent steps. In the step S2714, the cache control program deletes the first entry of the storage list. The cache control program determines in the step S2715 whether or not a remaining entry is present in the storage list. In the presence of a remaining entry, the cache control program returns to the operation of the step S2703, and continues to perform the releasing operation of the cache area having a low use frequency to the other storage.

When determining in the step S2715 the absence of a undeleted entry in the storage list, that is, that even the execution of the releasing operation of the cache area having a low use frequency to all the storages ends in a failure in the security of the necessary cache size, the cache control program returns an error telling a failure in the security of an unoccupied area for the necessary cache content to the caller in the error handling operation of the step S2716.

FIG. 29 is a flow chart of the content registration program 201 in the client 10.

In a step S2901, first, the content registration program is connected to the media server 11 according to the protocol supplied from the media server 11. When the content registration program determines the type of a registration request, that is, the update registration or deletion of the already-registered content in a step S2902, the content registration program informs the media server 11 of a target publish content name in a step S2903. When determining in the step S2902 the type of the registration request is a new registration, the content registration program skips the step S2903.

When determining in a step S2904 that the type of the registration request is a new registration or update registration of content, the content registration program transmits the registration-target content stored in the content storing area 202 of the hard disk 102 to the media server 11 in a step S2905. When determining in the step S2904 the type of the registration request is a deletion, the content registration program skips the step S2905. In a step S2906, the content registration program waits for a result response from the media server 11 and receives the result therefrom.

When the result from the media server 11 is the successful registration or deletion, the content registration program displays the publish content name attached to the registered or deleted content on the display unit 104 in a step S2907. For a registration error, the content registration program displays error information on the display unit 104 in the step S2907. When the reception of the result of the step S2906 and the display of the result of the step S2907 are completed, the content registration program releases the connection with the media server 11 in a step S2908.

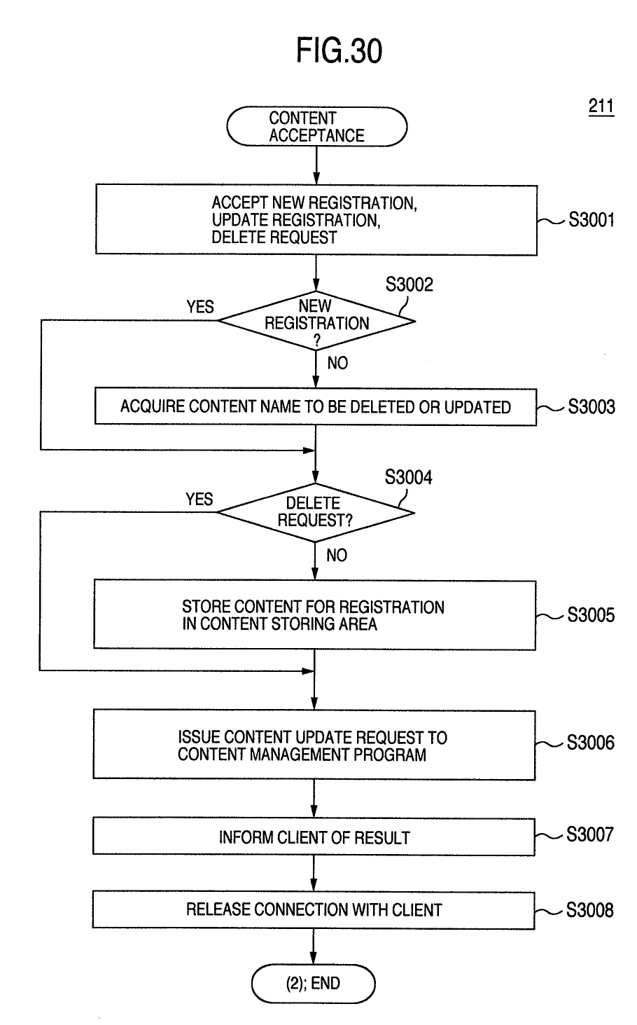

FIG. 30 is a flow chart of the content acceptance program 211 in the media server 11.

In a step S3001, the content acceptance program waits for and accepts a request of the new registration, update registration or deletion from the client 10. The content acceptance program determines in a step S3002 the type of the accepted request. When the request type is a deletion or update registration, the content acceptance program acquires a public content name to be deleted or updated in a step S3003. When determining in the step S3002 that the type of the accepted request is a new registration, the content acceptance program skips the step S3003.

When determining in a step S3004 that the type of the accepted request is a new registration or update registration, the content acceptance program acquires a content to be registered and stores it in the content storing area 216 in a step S3005. When determining in the step S3004 that the type of the accepted request is a deletion, the content acceptance program skips the step S3005. In a step S3006, the content acceptance program requires the content management program 212 to update the content. In a step S3007, the content acceptance program informs the client 10 of the result. In a step S3008, the content acceptance program releases its connection with the client and terminates its operation.

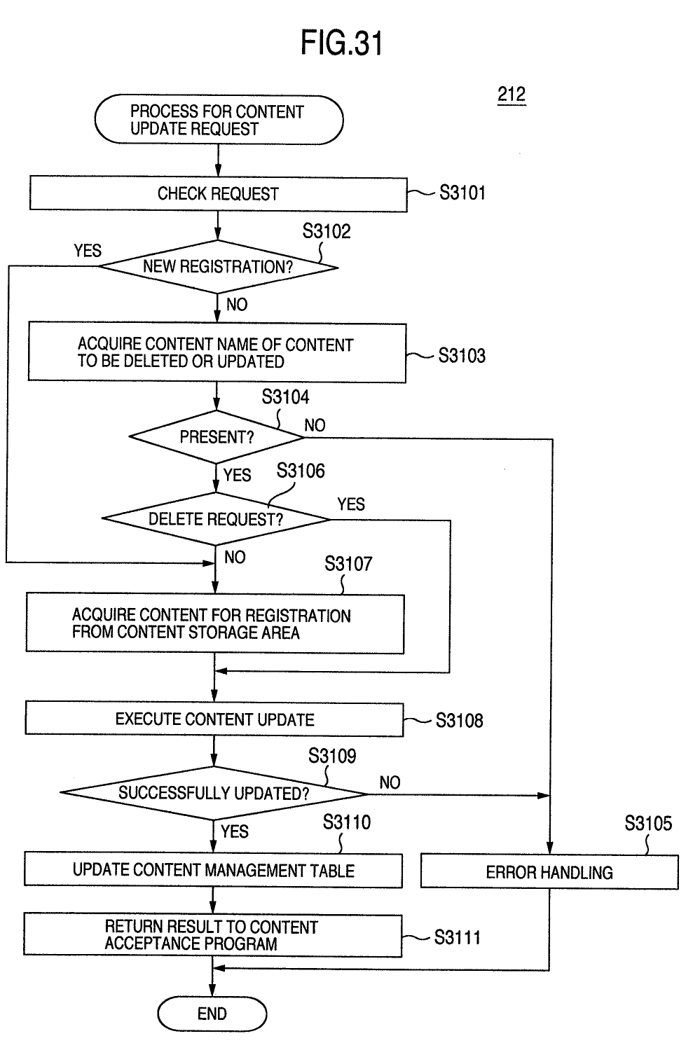

FIG. 31 is a flow chart of a process for content update request in the content management program 212 of the media server 11. When receiving a content update request from the content acceptance program 211, the content management program executes its operation.

In a step S3101, the content management program checks the type of a request. When determining in a step S3102 that the type of the request is a new registration, the content management program proceeds to a step S3107. When determining the type of the request is a deletion or an update registration in the step S3102, the content management program acquires the content name 904 of the content having the specified public content name 901 from the content management table 215 in a step S3103.

In a step S3104, the content management program determines whether or not the content having the specified public content name is present in the content management table 215. In the absence of such a content, the content management program returns error information to the content acceptance program 211 in the error handling operation of a step S3105. When determining in the step S3104 the presence of the content having the specified public content name 901 in the content management table 215, the content management program determines the type of the request in a step S3106. In the case of an update registration, the content management program proceeds to the step S3107. In the case of a deletion, the content management program skips the step S3107 and goes to a step S3108.

In the step S3107, the content management program acquires the registered content stored in the content storing area 216. In the step S3108, the content management program executes the content updating operation with the request type and the content name acquired in the step S3103 as arguments in the case of a deletion; with the request type and a content attribute (e.g., a value set in the header 402 of the content) as arguments in the case of a new registration; and with the request type, the content name acquired in the step S3103, the bit rate acquired from the content attribute, and the content as arguments in the case of an update registration.

When determining in a step S3109 that the content update became an error, the content management program performs an error handling operation to return error information to the content acceptance program 211 in the step S3105. When determining in the step S3109 that the content update was successful, the content management program updates the content management table 215 in a step S3110. More specifically, when the request type is a new registration, the content management program adds an entry to the content management table 215. When the request type is an update registration, the content management program sets the content name of the registered content for the content name 904 of the update-target content of the content management table 215. When the request type is a deletion, the content management program deletes the entry of the target content of the content management table 215. In a step S3111, the content management program returns the content name 904 of the content registered or deleted as the update result to the content acceptance program 211.

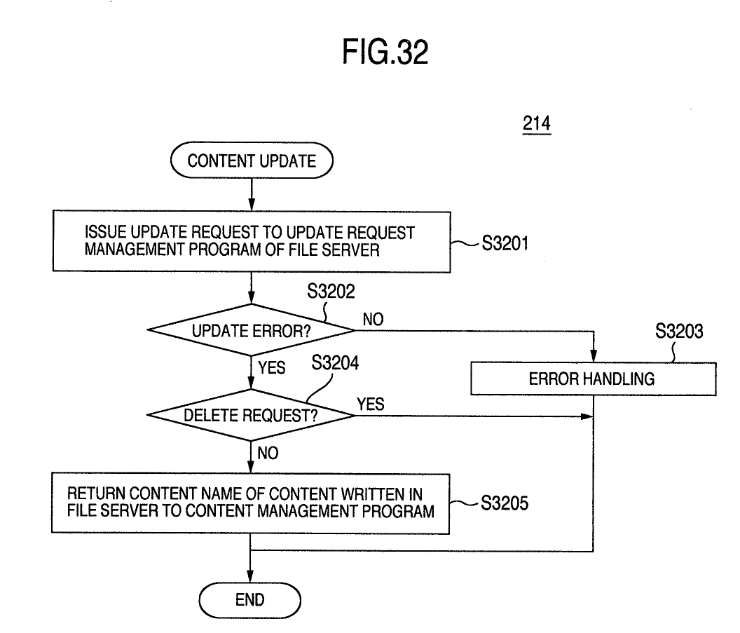

FIG. 32 is a flow chart of the content update program 214 in the media server 11.

In a step S3201, when the content update program is called through the content update request process of the content management program 212, the content update program requires the update request management program 244 to update the content. When determining in a step S3202 that the execution result of the update request to the update request management program 244 is an error, the content update program returns the error information to the content management program 212 as the error operation in a step S3203.

When determining in the step S3202 that the execution result of the update request to the update request management program 244 was successful, the content update program proceeds to a step S3204. When determining in the step S3204 that the request type is a new registration or an update registration, the content update program returns the content name (the content name returned from the update request management program 244) of the content written in the file server 14 to the content update request process of the content management program 212 as the caller in a step S3205, and terminates its operation. When determining in the step S3204 that the request type is a deletion, the content update program terminates its operation.

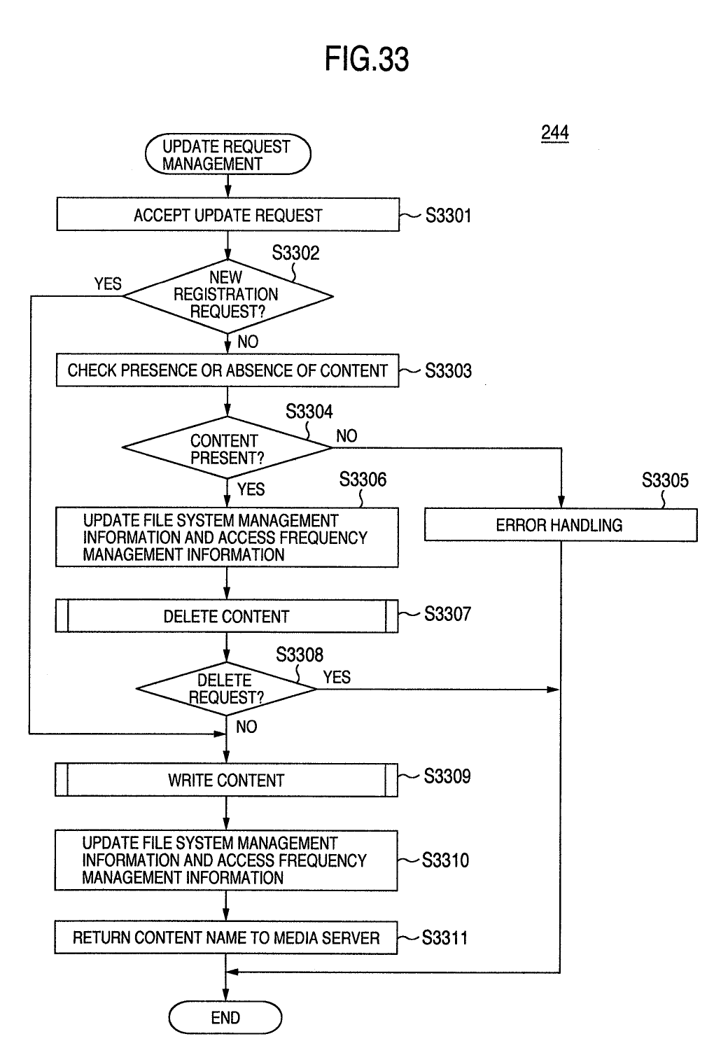

FIG. 33 is a flow chart of the update request management program 244 in the file server 14.

In a step S3301, the update request management program accepts an update request from the content update program 214 of the media server 11. In a step S3302, the update request management program determines the type of the request. When determining that the request type is a new registration, the update request management program proceeds to a step S3309. When determining that the request type is an update registration or deletion in the step S3302, the update request management program causes execution of the file system management program 240 to check the presence or absence of a content having the specified content name in a step S3303. The processing content of the file system management program 240 for check of the presence or absence of a content is as mentioned above by using FIG. 12.

When determining the absence of the specified content in a step S3304, the update request management program returns an error indicative of the absence of the content to the media server 11 in the error handling operation of a step S3305, and terminates its operation. When determining the presence of the specified content in the step S3304, the update request management program requires the file system management program 240 to delete the target content from the file system management information storing area 249, and further requires the access frequency management program 242 to delete the deletion-target content from the content access frequency management table 1400 or to delete the entry of the update-target content in a step S3306.

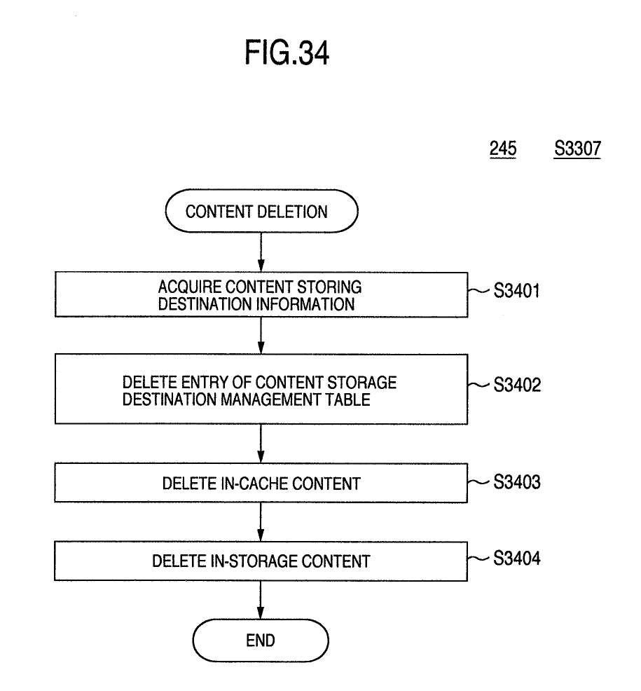

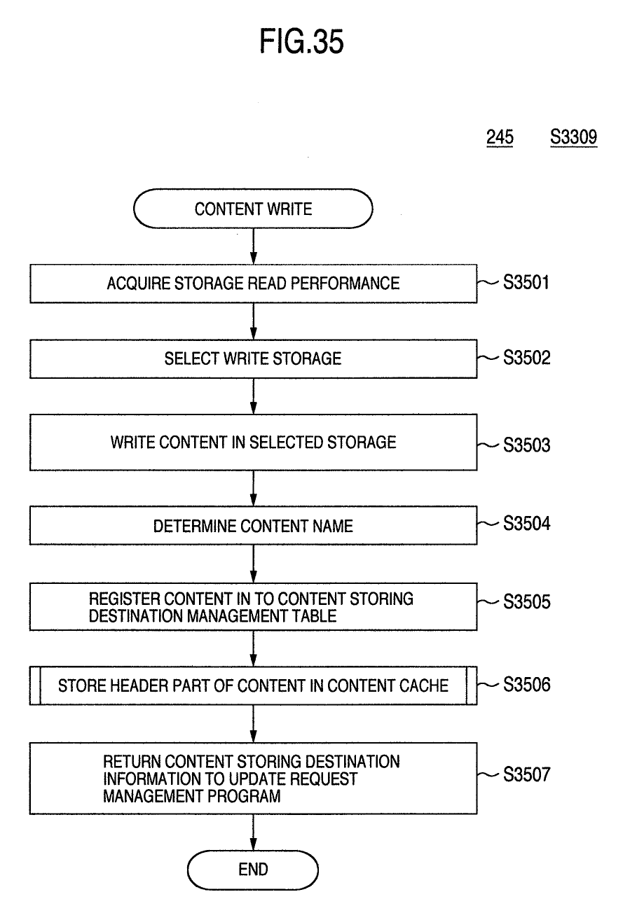

In a step S3307, the update request management program requires the update control program 245 to delete the content. The content deleting operation of the update control program 245 will be explained later by using FIG. 34. In a step S3308, the update request management program determines the type of the request. When the request type is a deletion, the update request management program terminates its operation. When the request type is a new registration or an update registration in the step S3308, the update request management program requires the update control program 245 to write the content in the step S3309. The writing operation of the content of the update control program 245 will be explained later by using FIG. 35.

In a step S3310, the update request management program requires the file system management program 240 to add information about the registration-target content in the file system management information storing area 249, and further requires the access frequency management program 242 to record the entry of the registration-target content in the content access frequency management table 1400. In a step S3311, the update request management program returns a content name for uniquely identifying the content in the file server 14 to the media server 11.

FIG. 34 is a flow chart of a content deletion process in the update control program 245 of the file server 14.

In a step S3401, the update control program acquires information about the cache storing destination 1606 of the deletion-target content and about the storage storing destination 1607 thereof from the content storing destination management table 248. In a step S3402, the update control program deletes the entry of the deletion-target content from the content storing destination management table 248. In a step S3403, the update control program deletes the content in the content cache 143 by releasing the cache area having the header part 261 of the content in the content cache 143 stored therein with use of the information on the cache storing destination 1606. In a step S3404, the update control program deletes the content in the storage 161 by releasing the storing area of the content 260 stored in the storage 161 on the basis of the information on the storage storing destination 1607, and terminates its operation.

FIG. 35 is a flow chart of a content write process in the update control program 245 of the file server 14.

In a step S3501, the update control program calls the storage performance referring process (refer to FIG. 23) of the storage performance management program 247, and acquires read performances of all the storages 161. In a step S3502, the update control program selects (determines) the storage 161 of the content storing destination on the basis of the storage read performance 2200 of the storage 161, the limit value of the storage read performance 2203, information about the bit rate of the write-target content, and information about the unoccupied capacity of the storage 161. When selecting (determining) the storage 161 of the storing destination, the update control program selects the storage 161 having the performance margin value corresponding to a subtraction of the limit value of the storage read performance 2203 from the storage read performance 2200 exceeding a predetermined threshold, from the storages 161 having the limit values of the storage read performance 2203 exceeding the replay rate (bit rate) of the write target. When a plurality of the target storages 161 exist, the update control program selects one of the storages 161 having, for example, the largest unoccupied area.

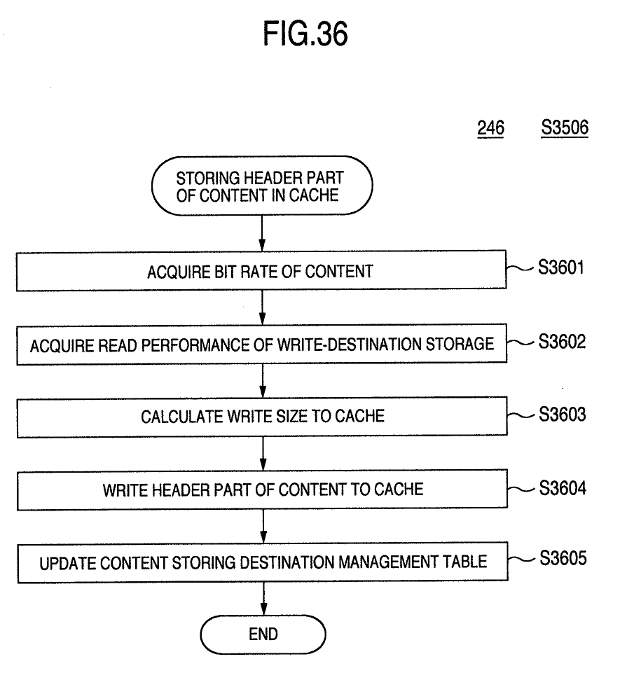

In a step S3503, the update control program writes the write-target content in the selected storage 161. In a step S3504, the update control program determines a content name for uniquely identifying a content in the file server 14. For determination of the content name, for example, the update control program determines the title or name of a content generated according to a predetermined rule as the content name. In a step S3505, the update control program registers the entry of the written content in the content storing destination management table 248. In a step S3506, the update control program stores (writes) the header part 261 of the content 260 written in the storage 161 in the content cache 143. A procedure of writing the header part 261 of the content in the content cache 143 will be explained later by using FIG. 36. In a step S3507, the update control program returns the content name of the written content and information about the content storing destination to the update request management program 244, and terminates its operation.

In this connection, as a procedure of determining the storage 161 as a storing destination in the step S3502 in the above content writing process of the update control program 245, any of two procedures (1) and (2) which follow is used, which is also included in the present embodiment.

(1) In the step S3502, the update control program selects one of the storages 161 having the nearest average value of the bit rates 1603 of the content stored therein to the bit rate of the content to be registered, which is calculated on the basis of information about the bit rate of the write-target content and information about the bit rates 1603 of the content stored in the storages 161 obtained from the content storing destination management table 248. When a plurality of the storages 161 are present as the target, the update control program selects one of the storages 161 having the largest unoccupied area.

(2) In the step S3502, the update control program selects one of the storages 161 having the bit rate of the content to be registered coinciding with the bit rate 1603 of all the contents stored in the storage 161, on the basis of information about the bit rate of the write-target content and information about the bit rates 1603 of content stored in the storages 161 obtained from the content storing destination management table 248 in order to unify the bit rates of content stored in the single storage 161. When a plurality of the target storages 161 are present, the update control program selects one of the storages 161 having the largest unoccupied area.

FIG. 36 is a flow chart of operations of storing the header part of the content 261 in the content cache 143 under control of the cache control program 246 of the file server 14.

In a step S3601, the cache control program acquires the bit rate of the content 260 written in the storage 161 from the content storing destination management table 248. In a step S3602, the cache control program acquires the storage read performance 2200 of the storage 161 having the content written therein under control of the storage performance management program 247. In a step S3603, the cache control program calculates the size of the header part 261 of the content necessary for writing in the content cache 143 on the basis of the storage read performance 2200. The size is such a size (minimum cache size) that can store the header part 261 of the content having a size capable of being replayed for a time necessary for reading out one unit of content block from the storage 161 having the content 260 stored therein.

In a step S3604, the cache control program reads out the header part 261 of the content having the calculated size from the content 260 stored in the storage 161, and writes (stores) it in the content cache 143. In a step S3605, the cache control program records the size of the header part 261 of the content stored in the content cache 143 in the cache size 1605 of the content storing destination management table 248, and records the storing destination in the content cache 143 of the header part of the content 261 in the cache storing destination 1606 of the content storing destination management table 248 to thereby update information on the content storing destination management table 248.

It is assumed in the present embodiment that the management of the content cache, the content reading operation, and the content registering operation are controlled by such means as shown by (1) to (9) given below.

(1) Means for finding a time necessary for reading out on content block as a distribution and management unit for each content from the storage with use of information about the bit rate of a content (such as a video stream) and about a data read performance from the storage having the content stored therein.

(2) With respect to each content, a means for calculating a content size necessary for replaying the content in the distribution destination for the time found in the means (1), reading out the header part of the content having a size exceeding the calculated size in a range storable in the content cache from the storage, and stores it in the high-speed-readable content cache on the file server having a size larger than a sum of the calculated sizes.

(3) In response to a content read request, means for first reading out the header part of the content stored in the content cache by the means (2), determining a read start time of the content stored in the storage so as to prevent stoppage of content replay in the client on the basis of the time necessary for the replay of the header part of the content and the time necessary for reading out one content block from the storage, and stopping reading out of the content stored in the storage before the determined content read start time.

(4) When there is a read request for the same content to complete the distribution of the content stored in the content cache during the content read stoppage by the means (3), means for integrate read requests of the content stored in the storage.

(5) When a plurality of contents are read out from the single storage, means for preventing replay stoppage in the client by preferentially reading out one of the contents having the shortest time until the replay completion of the already-distributed contents.

(6) When the read frequency of the content stored in a storage is increased so that the read performance of the storage becomes not larger than a limit value obtained from the replay rate (bit rate) of the read content, means for reducing the access frequency to the storage in such a manner that the storage read performance can be not larger than the limit value by increasing the size of the header part of the content cache of the content stored in the storage.

(7) For a content having the increased size of the header part in the means (6), means for efficiently reducing the access frequency to the storage by preferentially allocating a content having a high access frequency.

(8) When the capacity of the content cache becomes insufficient in the means (6), means for securing a necessary capacity by decreasing the size of the header part of the content cache of the content stored in the storage having the content read program from the storage exceeding the replay rate (bit rate) in the client.

(9) Upon registration of a content, a means for selecting one of the storages as a registration destination with use of the bit rate of the content, the storage read performance, and the bit rate of the content already registered in the storage.

In accordance with the present embodiment, the file server stores the header part of a content cut out from the head of the content in the content cache which can read out a content at a speed higher than the storage. When accepting a content read request from a client, the file server returns the header part of the content stored in the content cache to the client, and also returns the remaining part of the content stored in the storage subsequent to the returned header part of the content to the client. With such an arrangement, the amount of resources necessary for the storage of the content can be prevented from being increased, and a wait time taken from the issuance of the content read request to the start of replay of the content in the client can be shortened.

In general, an access frequency to a content stored in a media server is abruptly increased and reaches a peak in a short time after registration of the content, and subsequently gradually decreased. With respect to such a content, even when such a cache server as to allocate a fixed cache size to each content is installed, there is a high possibility that an access frequency exceeding the performance of the cache server to the content takes place. In the present embodiment, meanwhile, the size of the cache for storing the header part of the content can be modified according to the access frequency to the content and the read performance can be dynamically controlled.

It should be further understood by those skilled in the art that although the foregoing description has been made on embodiments of the invention, the invention is not limited thereto and various changes and modifications may be made without departing from the spirit of the invention and the scope of the appended claims.

1. A content management method based on a file server being capable of communicating with one or a plurality of storage servers having one or more storages and one or a plurality of clients which issue a content read request and having a content cache being capable of storing part of a content stored in said storage, said method comprising the steps of:
storing a header part of content cut out from a head of said content in said content cache which can read out the content at a speed higher than said storage;
returning the header part of the content stored in said content cache to said client when accepting the content read request from said client; and
returning a remaining part of the content stored in said storage subsequent to said returned header part of the content to said client.

2. A content management method according to claim 1, wherein said file server determines a time at which reading of the content stored in said storage is started on the basis of a time at which the header part of the content stored in said content cache is returned to said client, a replay time of said header part of the content in said client, and a time necessary for reading out one content block as a unit to be returned to said client from the storage and returning the read-out content block to said client.

3. A content management method according to claim 2, wherein said file server calculates a time necessary for reading out said one content block from the storage and returning the read-out content block to said client on the basis of a size of one content block read out from said storage and a read performance of the storage storing said content therein.

4. A content management method according to claim 2, wherein said file server, when receiving a read request from said client to the same content before a time of starting to read the content stored in said storage, executes single read request of the content from said storage into which the read requests are integrated, and returns said content read out from said storage to said client which issued the read request which are integrated to said single read request.

5. A content management method according to claim 2, wherein said file server, when said content is stream data, uses a replay time of the content calculated by using a size of the header part of said content and a bit rate as an attribute of the stream data as the replay time of said header part of content in said client, and uses a size calculated by using the bit rate as the attribute of the stream data as a size of the one content block.

6. A content management method according to claim 5, wherein said file server, when a plurality of reads are carried out on one or a plurality of contents stored in the single storage, preferentially executes one of the reads having the earliest replay completion time obtained by adding a replay time calculated by using the size of the header part of the content stored in said content cache, a size of the content already read out from the storage and returned to said client, and the bit rate as an attribute of the stream data of the content to a time at which the header part of the content stored in said content cache is returned to said client.

7. A content management method according to claim 5, wherein said file server, when selecting a storage in which the content is to be registered, selects one of the storages having a storage read performance, which is obtained by monitoring a read performance from the storage, is higher than a limit value determined on the basis of the bit rate of the content to be registered, as the content registering storage.

8. A content management method according to claim 5, wherein said file server, when selecting a storage for a content to be registered, selects one of the storages having maximum one of the bit rates of contents stored in said storages higher than a bit rate of the content to be registered, as the storage which registers the content.

9. A content management method according to claim 5, wherein said file server, when selecting a storage for a content to be registered, selects one of the storages having an average value of the bit rates of contents stored in said storage nearest to a bit rate of the content to be registered, as the storage which registers the content.

10. A content management method according to claim 5, wherein said file server, when selecting a storage for a content to be registered, selects one of the storages having the same bit rate of all the contents stored in said storage as a bit rate of the content to be registered, as the storage which registers the content.

11. A content management method according to claim 5, wherein said file server determines a size of the header part of the content cut out from the head of said content and stored in said content cache on the basis of a time necessary for reading out one content block as a unit of returning said content from storage having said content stored therein to said client and a bit rate of said content.

12. A content management method according to claim 5, wherein said file server, when a storage read performance obtained by monitoring a read performance from a storage is not larger than a threshold of a read performance found from the bit rate of the content stored in the storage, increase a size of the header part of the content of said storage stored in said content cache until said storage read performance exceeds said threshold of the read performance.

13. A content management method according to claim 12, wherein said file server, the content which is increased the size of the header part of the content stored in said content cache is selected in a decreasing order of storage access frequency to the content.

14. A content management method according to claim 12, wherein said file server, when increasing the size of the header part of the content stored in said content cache and when an unoccupied area of said content cache is insufficient, selects another storage having the storage read performance exceeding the threshold of the read performance, and increases the unoccupied area of the content cache by reducing the size of header part of the content of said selected storage stored in said content cache.

15. A content management method according to claim 14, wherein said file server, the content which is reduced the size of the header part of the content stored in said content cache is selected in an increasing order of access frequency to the content.

16. A file server communicatable with one or a plurality of storage servers having one or more storage and with one or a plurality of clients issuing a content read request and having a content cache capable of storing part of a content stored in said storage and also having a processor for processing information, wherein said processor stores a header part of the content cut off from a head of said content in said content cache which can read out the content at a speed higher than said storage, returns the header part of the content stored in said content cache to said client when accepting a content read request from said client, and returns a remaining part of the content stored in said storage subsequent to said returned content header part to said client.

17. A file server according to claim 16, wherein said processor determines a time at which reading of the content stored in said storage is started, on the basis of a time at which the header part of the content stored in said content cache is returned to said client, a replay time of said content header part in said client, and a time taken from reading of one content block from the storage as a unit of returning the content to said client to returning thereof to said client.

18. A read control program for executing content read control in a computer which can communicate with one or a plurality of storage servers having one or more storages and with one or a plurality of clients issuing a content read request and having a content cache capable of storing part of a content stored in said storage, wherein said read control program causes said computer to store a content header part cut off from a head of said content in said content cache which can read the content at a speed higher than said storage, to return the header part of the content stored in said content cache to said client when accepting the content read request from said client, and to execute returning of a remaining part of the content in said storage subsequent to said returned content header part to said client.
